(19) United States
(12) Patent Application Publication
(10) Pub. No.: US 2013/0332372 A1
(43) Pub. Date: Dec. 12, 2013

(54) REAL ESTATE SYSTEMS AND METHODS FOR PROVIDING LEAD NOTIFICATIONS BASED ON AGGREGATE INFORMATION

(71) Applicant: Ryan Slifer Marshall, Irvine, CA (US)

(72) Inventor: Ryan Slifer Marshall, Irvine, CA (US)

(21) Appl. No.: 13/490,192

(22) Filed: Jun. 6, 2012

(51) Int. Cl. G06Q 50/16

(52) U.S. Cl. 705/313

(57) ABSTRACT

In one example embodiment, the systems, methods and devices provide notifications based on an occurrence of a lead triggering event for real estate property assigned to a real estate group. In one example embodiment, an information processing system receives data indicating an assignment of real estate property data to a real estate group. Further, for the real estate group, the information processing system may receive a request for notification of lead triggering events associated with the real estate property data assigned to the real estate group. For each real estate property data assigned to the real estate group, the information processing system may determine whether a lead triggering event occurs based on received lead triggering event data. In one example embodiment, in response to a determination of an occurrence of a lead triggering event, the information processing system generates notification data representative of the occurrence of the lead triggering event.

### BACKGROUND

To increase property sales, a real estate agent must successfully identify and pursue potential clients and potential properties for listing, commonly known as leads. Pursuing leads can be a frustrating, time consuming, and difficult. Real estate agents can spend hours searching through available information to identify good leads to pursue. Such manual searching can be extremely inefficient and time consuming for the agent.

To increase efficiency and property sales, it is desirable to provide real estate professional with new types of real estate systems that provide leads. Accordingly, a need exists for further development of real estate systems.

### SUMMARY

In one example embodiment, the systems, methods and devices provide notifications based on an occurrence of a lead triggering event for real estate property assigned to a real estate group. In one example embodiment, an information processing system receives data indicating an assignment of real estate property data to a real estate group. Further, for the real estate group, the information processing system may receive a request for notification of lead triggering events associated with the real estate property data assigned to the real estate group. For each real estate property data assigned to the real estate group, the information processing system may determine whether a lead triggering event occurs based on received lead triggering event data. In one example embodiment, in response to a determination of an occurrence of a lead triggering event, the information processing system generates notification data representative of the occurrence of the lead triggering event.

Additional features and advantages are described herein, and will be apparent from the following Detailed Description and figures.

### BRIEF DESCRIPTION OF THE FIGURES

FIG. 1 is a high level block diagram of an example network communicating system, according to an example embodiment of the system disclosed herein.

FIG. 2 is a detailed block diagram showing an example of a computing device, according to an example embodiment of the system disclosed herein.

FIG. 3 is a block diagram of an example network structure in accordance with one example embodiment of the system disclosed herein.

FIG. 4 is a flowchart illustrating an example procedure for providing notification based on an occurrence of a lead triggering event for real estate property assigned to a real estate group.

FIG. 5 is a block diagram showing an example data architecture, according to an example embodiment of the system disclosed herein.

FIGS. 6A, 6B, 6C, 6D, 6E, 6F, 6G, 6H, 6I, 6J, 6K and 6L are front views an example realtor interface, illustrating assigning real estate property data to a real estate group based on a created search area or boundary, according to an example embodiment of the present disclosure.

FIGS. 7A and 7B are front views an example realtor interface, illustrating, for each real estate group, requesting notifications of any lead triggering events associated with the real estate property data assigned to the real estate group, according to an example embodiment of the present disclosure.

FIG. 8 is an example screen shot showing a notification being provided based on received data representative of lead triggering event occurrences, according to an example embodiment of the present disclosure.

FIGS. 9A, 9B and 9C are example screen shots illustrating the search area being adjusted, according to an example embodiment of the present disclosure.

FIG. 10 is example screen shot showing an example drop down box for selecting a county, according to an example embodiment of the present disclosure.

FIG. 11 is example screen shot showing an example drop down box for selecting a lead type, according to an example embodiment of the present disclosure.

FIG. 12 illustrates an example screen shot showing an example filter window, according to an example embodiment of the present disclosure.

### DETAILED DESCRIPTION

The present disclosure relates in general to a system for providing notifications based on occurrences of lead triggering events for real estate property assigned to a real estate groups. Briefly, in an example embodiment, a search area module receives selections to create a search area for a map. A real estate property generation module generates real estate property data based the created search area. Thereafter, in response to a realtor request, a real estate property assignment module assigns the real estate property data to a real estate property group. In response to a determination that a lead triggering event occurs for real estate property assigned to a real estate group, the notification generate a notification indicative of the occurrence of the lead triggering event.

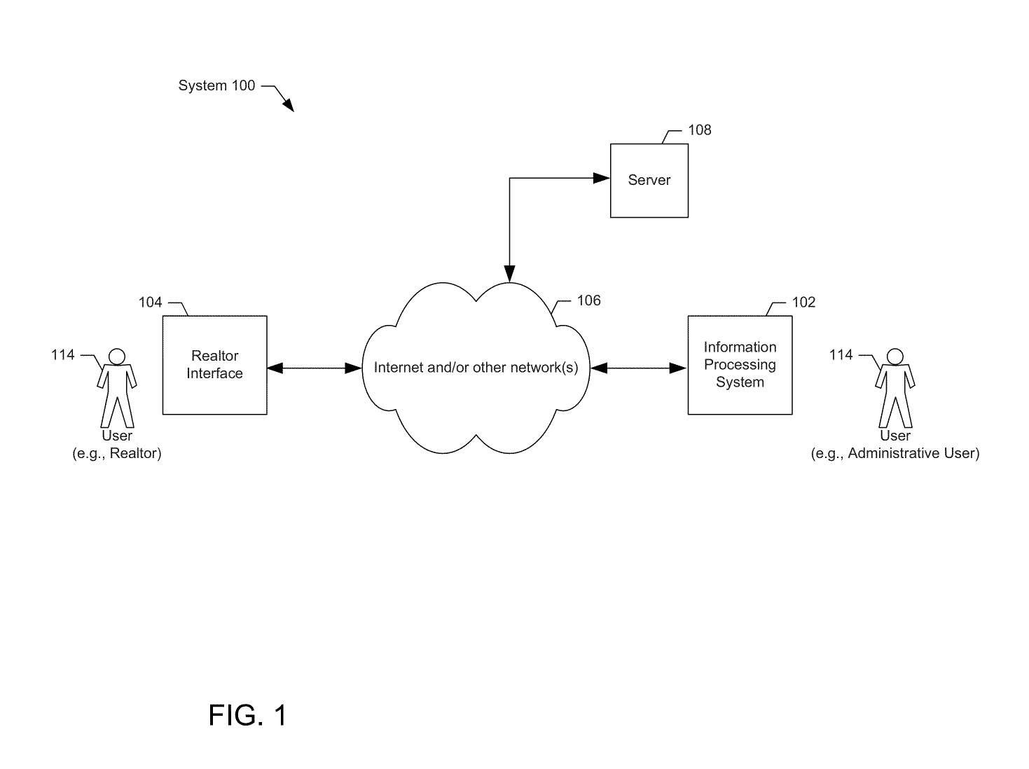

The present system may be readily realized in a network communications system. A high level block diagram of an example network communications system 100 (“system 100”) is illustrated in FIG. 1. In this example, system 100 includes realtor interface 104 and information processing system 102. Realtor interface 104 may include a variety of devices, such as desktop computers which typically include a user display for providing information to users and various interface elements as will be discussed in further detail below.

Realtor interface 104 may include a cellular phone, a personal digital assistant, a laptop computer, a tablet computer, or a smart phone. In some example embodiments, realtor interface 104 may include any mobile digital device such as Apple Inc.'s iPhone™, iPod Touch™ and iPad™ Further, realtor interface 104 may include smart phones based on Google Inc.'s Android™, Nokia Corporation's Symbian™ or Microsoft Corporation's Windows Mobile™ operating systems or Research In Motion Limited's Blackberry™ etc. In these embodiments, realtor interface 104 is preferably configured to download, install and execute various application programs.

Realtor interface 104 may communicate with information processing system 102 via a connection to one or more communications channels 106 such as the Internet or some other data network, including, but not limited to, any suitable wide area network or local area network. It should be appreciated that any of the devices and systems described herein may be directly connected to each other instead of over a network. At least one server 108 may be part of network communications system 100, and may communicate with information processing system 102 and realtor interface 104.

Information processing system 102 may interact with a large number of users at a plurality of different realtor interfaces 104. Accordingly, information processing system 102 is typically a high end computer with a large storage capacity, one or more fast microprocessors, and one or more high speed network connections. Conversely, relative to a typical information processing system 102, each realtor interface 104 may include less storage capacity, a single microprocessor, and a single network connection.

It should be appreciated that users as described herein may include any person or entity which uses the presently disclosed system and may include a wide variety of parties. For example, the users described herein may refer to various different entities, including real estate professionals, agents, administrative users, realtors, mortgage brokers, sales agents, title representatives, mobile device users, private individuals, and/or commercial partners. It should also be appreciates that although the user in this specification is often described as a realtor, the realtor may be instead any of the users described herein.

Typically, information processing system 102 and/or servers 108 may store files, programs, databases, and/or web pages in memories for use by realtor interface 102, and/or other information processing systems 102 or servers 108.

Information processing system 102 and/or server 108 may be configured according to its particular operating system, applications, memory, hardware, etc., and may provide various options for managing the execution of the programs and applications, as well as various administrative tasks. Information processing system 102 and/or server 108 may interact via at least one network with at least one other information processing system 102 and/or server 108, which may be operated independently. Information processing systems 102 and servers 108 operated by separate and distinct entities may interact together according to some agreed upon protocol.

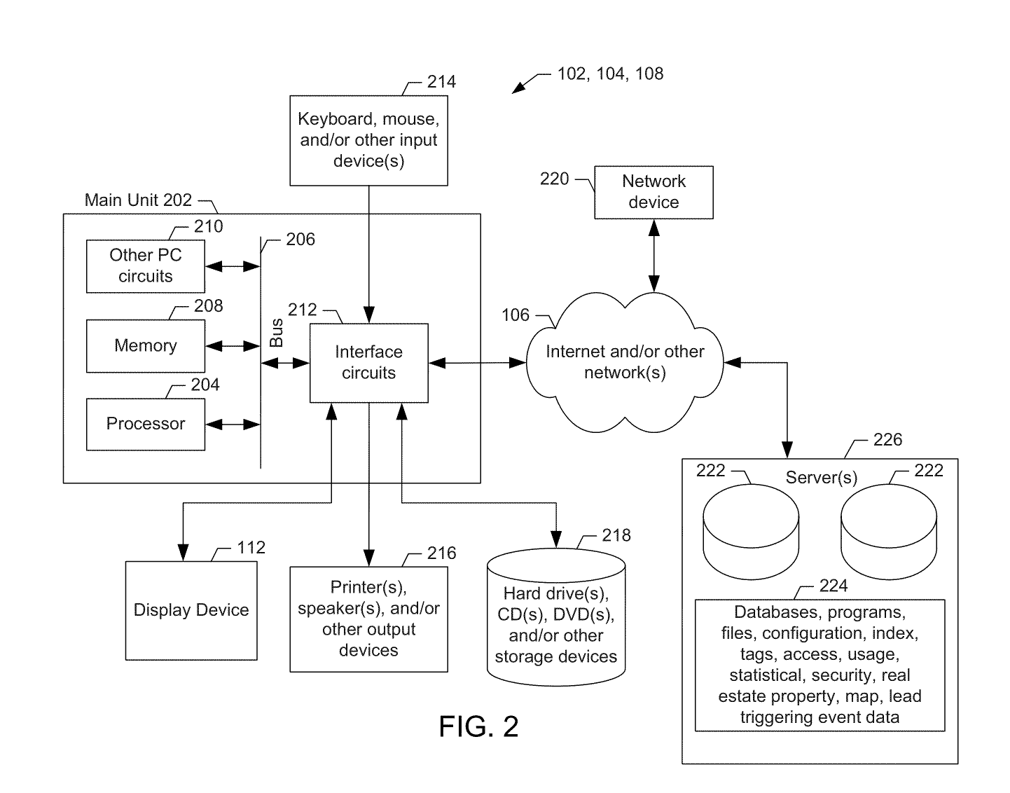

A detailed block diagram of the electrical systems of an example computing device is illustrated in FIG. 2. The example computing device may include any of the devices and systems described herein, including realtor interface 104, information processing system 102 and server 108. In this example, the example computing devices may include main unit 202 which preferably includes at least one processor 204 electrically connected by address/data bus 206 to at least one memory device 208, other computer circuitry 210, and at least one interface circuit 212. Processor 204 may be any suitable processor, such as a microprocessor from the INTEL® PENTIUM® family of microprocessors. Processor 204 may include one or more microprocessors, central processing units (CPUs), computing devices, microcontrollers, digital signal processors, or like devices or any combination thereof. Memory 208 preferably includes volatile memory and non-volatile memory. Preferably, memory 208 stores software program(s) that interact with the other devices in system 100 as described below. This program may be executed by processor 204 in any suitable manner. In an example embodiment, memory 208 may be part of a “cloud” such that cloud computing may be utilized by realtor interface 104, information processing system 102 and server 108. Memory 208 may also store digital data indicative of documents, files, programs, web pages, etc. retrieved from computing devices 102, 103 and 104 and/or loaded via input device 214.

Interface circuit 212 may be implemented using any suitable interface standard, such as an Ethernet interface and/or a Universal Serial Bus (USB) interface. At least one input device 214 may be connected to interface circuit 212 for entering data and commands into main unit 202. For example, input device 214 may be at least one of a keyboard, mouse, touch screen, track pad, track ball, isopoint, image sensor, character recognition, barcode scanner, and a voice recognition system.

As illustrated in FIG. 2, at least one display device 112, printers, speakers, and/or other output devices 216 may also be connected to main unit 202 via interface circuit 212. Display device 112 may be a cathode ray tube (CRTs), a liquid crystal display (LCD), or any other suitable type of display device. Display device 112 may be configured to generate visual displays during operation of realtor interface 104, information processing system 102 and/or server 108. For example, display device 112 may provide a user interface, which will be described in further detail below, and may display at least one web page received from realtor interface 104, information processing system 102 and/or server 108. A user interface may include prompts for human input from user 114 including links, buttons, tabs, checkboxes, thumbnails, text fields, drop down boxes, etc., and may provide various outputs in response to the user inputs, such as text, still images, videos, audio, and animations.

At least one storage device 218 may also be connected to main device or unit 202 via interface circuit 212. At least one storage device 218 may include at least one of a hard drive, CD drive, DVD drive, and other storage devices. At least one storage device 218 may store any type of data, such real estate property data, request notification data, lead triggering event data, realtor interface data, real estate group data, search area data, map data, notification data, lead type data, county data, user data, application program data, content data, statistical data, historical data, databases, programs, files, libraries, pricing data and/or other data, etc., which may be used by realtor interface 104, information processing system 102 and/or server 108.

Realtor interface 104, information processing system 102 and/or server 108 may also exchange data with other network devices 220 via a connection to network 106. Network devices 220 may include at least one server 226, which may be used to store certain types of data, and particularly large volumes of data which may be stored in at least one data repository 222. Server 226 may include any kind of data 224 including real estate property data, request notification data, lead triggering event data, realtor interface data, real estate group data, search area data, map data, notification data, lead type data, county data, user data, application program data, content data, statistical data, historical data, databases, programs, files, libraries, pricing data and/or other data, etc. Server 226 may store and operate various applications relating to receiving, transmitting, processing, and storing the large volumes of data. It should be appreciated that various configurations of at least one server 226 may be used to support and maintain system 100. In some example embodiments, server 226 is operated by various different entities, including private individuals, administrative users and/or commercial partners. Also, certain data may be stored in realtor interface 104, information processing system 102 and/or server 108 which is also stored on server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to realtor interface 104, information processing system 102 and/or server 108 can be controlled by appropriate security software or security measures. A user's access can be defined by realtor interface 104, information processing system 102 and/or server 108 and be limited to certain data and/or actions. Accordingly, users of system 100 may be required to register with realtor interface 104, information processing system 102 and/or server 108.

As noted previously, various options for managing data located within of realtor interface 104, information processing system 102 and/or server 108 and/or in server 226 may be implemented. A management system may manage security of data and accomplish various tasks such as facilitating a data backup process. The management system may update, store, and back up data locally and/or remotely. A management system may remotely store data using any suitable method of data transmission, such as via the Internet and/or other networks 106.

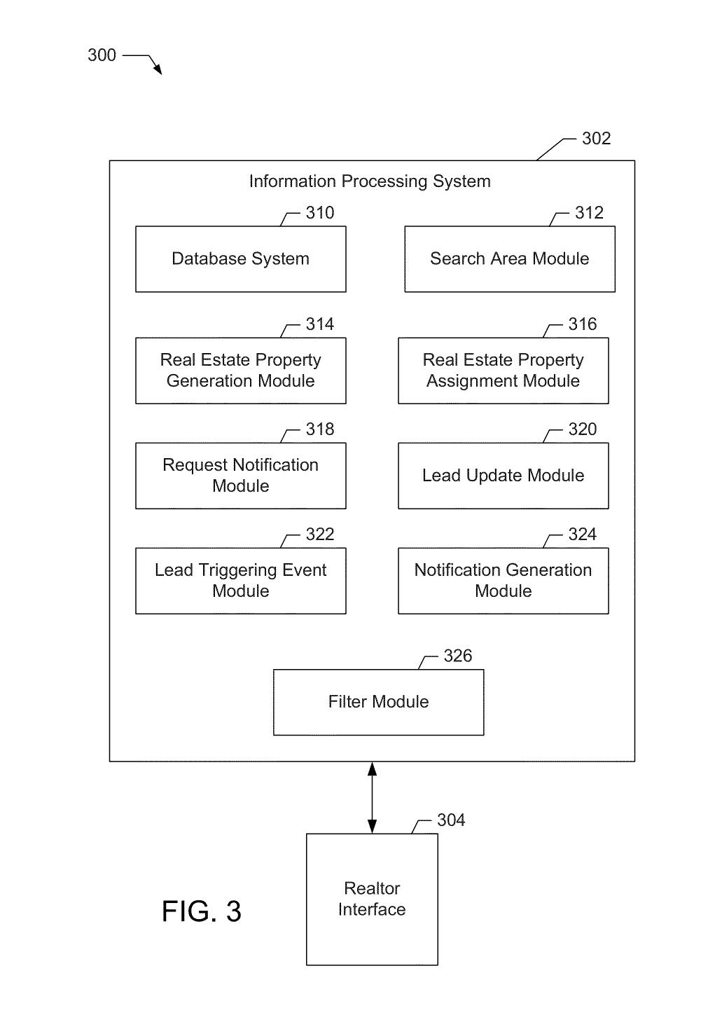

FIG. 3 is a block diagram showing an example network structure 300. In this example, network structure 300 includes information processing system 302 which is in communication with realtor interface 304. As described above, in some example embodiments, information processing system 302 is operated by an entity such an administrative user. It should be appreciated that information processing system 302 and realtor interface 304 illustrated in FIG. 3 may be implemented as information processing system 102 and realtor interface 104.

As illustrated in FIG. 3, in this example, information processing system 302 may include database system 310, search area module 312, real estate property generation module 314, real estate property assignment module 316, request notification module 318, lead update module 320, lead triggering event module 322, notification generation module 324, and filter module 326. Database system 310, search area module 312, real estate property generation module 314, real estate property assignment module 316, request notification module 318, lead update module 320, lead triggering event module 322, notification generation module 324 and filter module 326 may include software and/or hardware components, such as a field programmable gate array (FPGA) or an application specific integrated circuit (ASIC), which performs certain tasks. Database system 310, search area module 312, real estate property generation module 314, real estate property assignment module 316, request notification module 318, lead update module 320, lead triggering event module 322, notification generation module 324, and filter module 326 may advantageously be configured to reside on an addressable storage medium and configured to be executed on one or more processors. Thus, database system 310, search area module 312, real estate property generation module 314, real estate property assignment module 316, request notification module 318, lead update module 320, lead triggering event module 322, notification generation module 324 and filter module 326 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Database system 310 may include a wide variety of data. For example, database system may include any of the following data: real estate property data, request notification data, lead triggering event data, realtor interface data, real estate group data, search area data, map data, notification data, lead type data, county data, user data, application program data, content data, statistical data, historical data, databases, programs, files, libraries, pricing data and/or other data, etc. In one example embodiment, database system 310 includes applications which may be downloaded or requested by realtor interface 304.

In some example embodiments, search area module 312 creates a search area. In one example, search area module 312 creates the search area based on selected map positions. In another example, search area module 312 creates the search area based on an adjustable displayed search area.

In some example embodiments, real estate property generation module 314 is configured to generate real estate property data and cause the realtor interface to display the generated real estate property data. In some example embodiments, the real estate property data is generated based on a search area created by the search area module.

In some example embodiments, real estate property assignment module 316 is configured to assign real estate property data to a real estate group. In some example embodiments, real estate property assignment module 316 is configured to map real estate property data to a real estate group.

In some example embodiments, request notification module 318 is configured to receive requests for notifications of any lead triggering events associated with the real estate property data that is assigned to the real estate group. In some example embodiments, for each real estate group, request notification module 318 receives requests for notifications by selecting saved real estate group selections from displayed drop down boxes. In some example embodiments, for each real estate property in each real estate group, request notification module 318 receives requests for notifications by selecting saved real estate group selections from displayed drop down boxes. Such a configuration may allow a real estate professional to receive notifications for specific types of lead triggering events. For example, for a real estate professional may only desire to receive notifications based on whether a divorce was filed for any of the properties included in any of the farms created by the real estate professional.

In some example embodiments, lead update module 320 is configured to automatically search and retrieve data such as lead triggering event data. In some example embodiments, lead update module 320 may include one or more client-based software modules that an authorized user may download from a web site. Using a downloadable client-based software module and a local database may provide an advantage in that it complies with requirements of listing services where exported information from the listing service may only be used on a realtor's own system and may not be located on any third-party web-based servers available to multiple users.

In some example embodiments, update module 320 is configured to import or receive lead triggering event data from a plurality of different sources. The sources may include at least one of a Multiple Listing Service (“MLS”) system; a “for sell by owner” (“FSBO”) listing system; a foreclosure listings system; a sold MLS listings system; pre-foreclosure listings/notices of default systems; a census data system; a system providing refinance information; data and lien data; 1-800 number sign call leads; a system providing UCC filings; a system providing code violations; a system providing data indicating investors who are evicting tenants; a system providing data indicating any litigation being filed; and any other potential real estate lead. These other sources may include any source available in an electronic format, including sources generally available on the Internet or third party lead sources that compile lists of potential real estate property leads.

In some example embodiments, update module 320 is configured to match lead triggering event data with a real estate property based on owner identification information of the real estate property. For example, in one embodiment, an owner of a real estate property may also own a business. In this example, in response to a lien being filed on the business, update module 320 may match the occurrence of the filed lien on the business to the real estate property of the owner based on owner identification information such as name, address, etc. In this example, a real estate professional may receive a notification indicating that an entity has filed a lien on the business of the owner, which also owns a real estate property assigned to a real estate group being monitored by the real estate professional. In this example, because a lien was filed on the owner's business, the owner may be interested in selling real estate.

In some example embodiments, update module 320 is configured to receive selections of which sources to import or receive leading trigging event data. In some example embodiments, update module 320 is configured to receive selections indicating when to import or receive lead trigging event data from the sources. For example, in one embodiment, a source system may only be updated once a week. In this example, for that source system, update module 320 may be configured to import or receive lead triggering event data from the source once a week.

In some example embodiments, lead triggering event module 322 is configured to, for each real estate property data assigned to a real estate group, determine whether a lead triggering event occurs based on the received lead triggering event data. For example, in some example embodiments, lead triggering event module 322 determines that a lead triggering occurs for a real estate property in response to a change of any real estate property data associated with the real estate property. In another example, in response to receiving data representative of a notice of default being filed for a real estate property, for each real estate property assigned to the real estate group, lead triggering event module 322 determines that a lead triggering event occurs based on whether the notice of default corresponds to or matches the real estate property assigned to the real estate group.

In some example embodiments, after an occurrence of a lead triggering event, notification generation module 324 is configured to generate a notification. In some example embodiments, notification generation module 324 is configured to cause realtor interface 304 to display the notification based on the received lead triggering event data.

In some example embodiments, filter module 326 is configured to receive selections to filter real property data which may be generated by real estate property generation module 314. In some example embodiments, filter module 326 is configured to display a filter window which includes a plurality of selections, fields and check boxes. In these embodiments, filter module 326 filters based on any received selections or information input into the fields. In some example embodiments, filter module 326 filters the real estate property results based data representative of at least one of: divorce filings; probate filings; notices of sale; tax defaults; notices of default; cold leads; hot leads; expired leads; follow up leads; FSBO listings; properties just listed; properties just sold; type of leads (e.g., divorce, notice of default, tax line, etc.); listing date; name of the owner; address; city; zip code; street; county; purchase money first mortgage lender; beneficiary; trustee; trustor; price; loan amounts; building size; number of bedrooms; number of bathroom; number of units; year built; lot size; assessed value; improvement value; purchase date; property type; owner type; phone numbers on a “Do-Not-Call” registry; whether a property is bank owned; phone numbers; trustee number; loan data; sale date; sale location; delinquent amount; minimum bid; reason a notice of sale was filed; recorded date; MLS activity; whether a property is listed by another realtor; comparable properties; market trend; public sale; public financing; neighbor data; a number of days a property is on the market; property taxes; bankruptcy records; tax lien records; cash buyers; schools; population demographics; sales history of a property; comparable sales in the area; whether a phone number is on the National “Do-Not-Call” registry; environmental hazard reports; real estate properties; other property records; other court case filings; active MLS listings; sold MLS listings; expired MLS listings; foreclosure listings; and 1-800 sign call leads.

Although the above has been shown using information processing system 302 and realtor interface 304, there can be many alternatives, modifications, and variations. For example, some of the modules of the information processing system may be expanded and/or combined. Further, in some example embodiments, the functions provided by certain modules may be employed by a separate information processing system operated by a separate entity. In one example, information processing system 302 does not include database system 310. In this example, information processing system 302 may be configured to communicate with a separate database system which includes the data described in database system 310 shown in FIG. 3. Other systems may be inserted to those noted above. Depending upon the embodiment, database system 310, search area module 312, real estate property generation module 314, real estate property assignment module 316, request notification module 318, lead update module 320, lead triggering event module 322, notification generation module 324 and filter module 326 may be replaced. Further details of these systems are found throughout the present specification.

Information processing system 302 may process data received by realtor device 304 as well as other devices. For example, another computing device (e.g., a personal computer) may query data from database system 310 for use in a report, for selecting a question and/or for selecting an advertisement.

It should also be appreciated that certain modules of information processing system 302 may be considered to be part of realtor device 304, however, for discussion purposes, any modules and any engines of the information processing system are referred to as separate from realtor interface 304.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

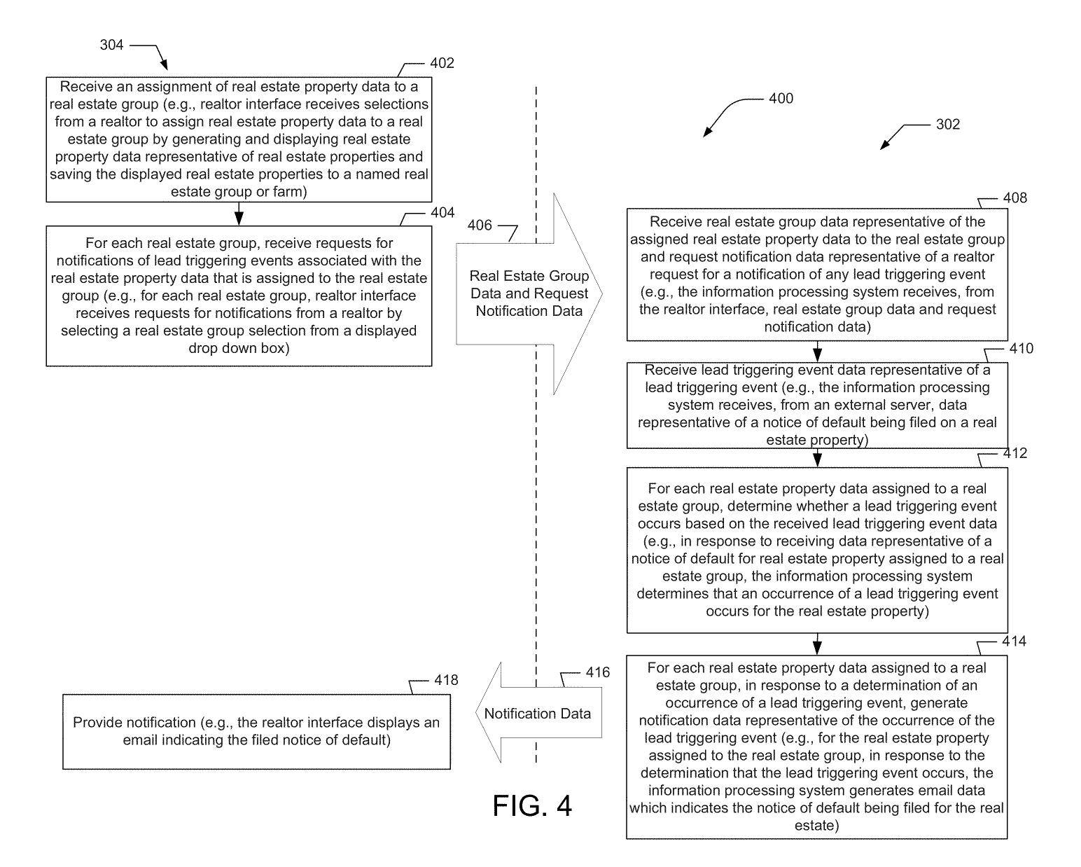

As illustrated in FIG. 4, a flowchart of an example process 400 includes providing a notification based on a determination of an occurrence of a lead triggering event for real estate property assigned to a real estate group. Preferably, process 400 is embodied in one or more software programs which are stored in one or more memories and executed by one or more processors. Although process 400 is described with reference to the flowchart illustrated in FIG. 4, it should be appreciated that many other methods of performing the acts associated with process 400 may be used. For example, the order of many of the steps may be changed, some of the steps described may be optional, and additional steps may be included. As shown in FIG. 4, data may flow between realtor interface 304 and information processing system 302.

More specifically, in one example, realtor interface 304 receives an assignment of real estate property data to a real estate group, as indicated by block 402. For example, in one example, realtor interface receives selections from a a realtor to assign real estate property data to a real estate group by generating and displaying real estate property data representative of real estate properties and saving or storing the displayed real estate properties to a named real estate group or farm. In some example embodiments, a real estate group may be referred to herein as a farm.

In some example embodiments, the real estate property data is generated based on a created search area positioned on a map. In some example embodiments, the real estate property data is generated based on an uploaded spreadsheet including data representing real estate properties.

As indicated by block 404, in this example, for each real estate group, realtor interface 304 may receive requests for notifications of any lead triggering events associated with the real estate property data that is assigned to the real estate group. For example, in some example embodiments, for each real estate group, the realtor interface receives requests for notifications by selecting previously saved real estate groups from displayed drop down boxes.

As indicated by arrow 406, realtor interface 304 may transmit real estate group data representative of assigned real estate property to a real estate group and request notification data representative of a realtor request for notifications of any lead triggering events to information processing system 302. In some example embodiments, realtor interface 304 may transmit the real estate group data and the request notification data to information processing system 302 using the Internet.

As indicated by block 408, in this example, the real estate group data and the request notification data may be received.

As indicated by block 410, lead triggering event data representative of a lead triggering event may be received. For example, in some example embodiments, the information processing system is configured to import or receive data from an external server.

For each real estate assigned to a real estate group, information processing system 302 may determine whether a lead triggering occurs based on the received lead triggering event data, as indicated by block 412. For example, in some example embodiments, information processing system 302 determines that a lead triggering occurs for a real estate property in response to a change of any real estate property data associated with the real estate property. In another example, in response to receiving data representative of a notice of default being filed for a real estate property, for each real estate property assigned to the real estate group, the information processing system determines whether the notice of default corresponds to or matches the real estate property assigned to the real estate group.

As indicated by block 414, in one example, for each real estate property data assigned to a real estate group, in response to a determination of an occurrence of a lead triggering event based on the received lead triggering event data, information processing system 302 may generate notification data representative of the occurrence of the lead triggering event. For example, in some example embodiments, for each real estate property assigned to a real estate group, in response to a determination that the notice of default corresponds to the real estate, the information processing system generates email data which indicates the notice of default being filed for the real estate.

Information processing system 302 may transmit the generated notification data to real estate interface 304 as indicated by arrow 416.

As indicated by block 418, in this example, realtor interface 304 provides a notification based on the received notification data representative of the occurrence of the lead triggering event. For example, in some example embodiments, the realtor interface displays an email indicating the filed notice of default.

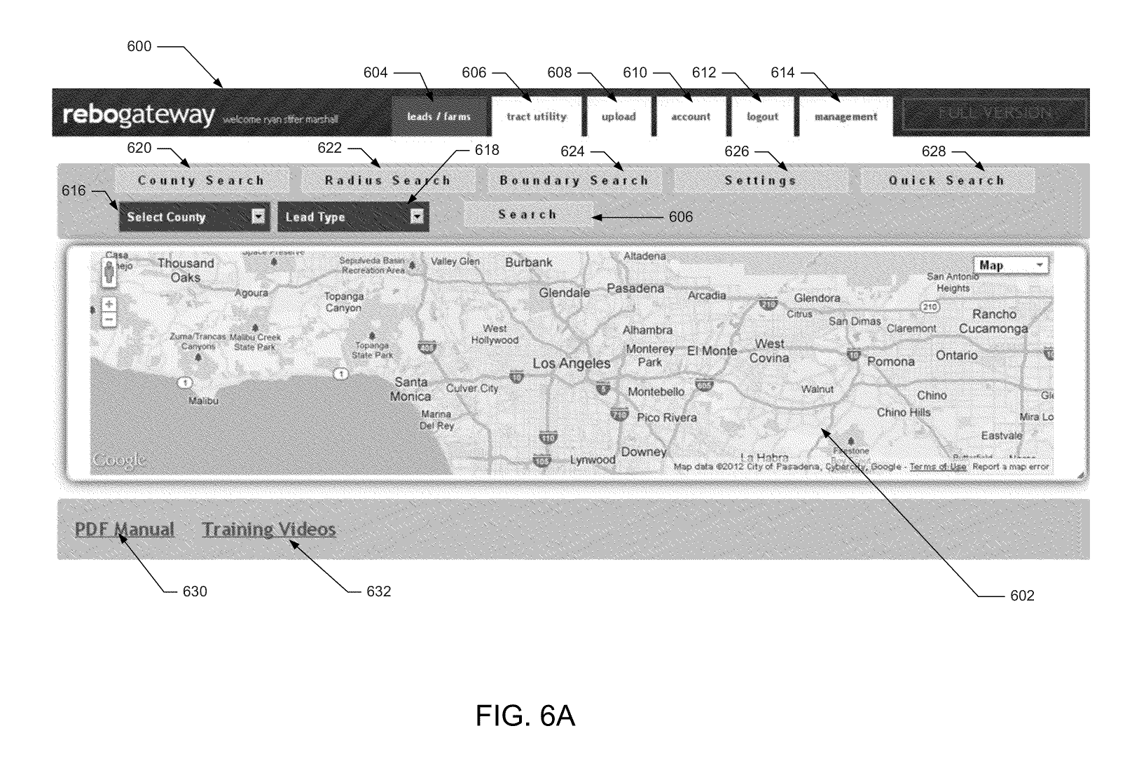

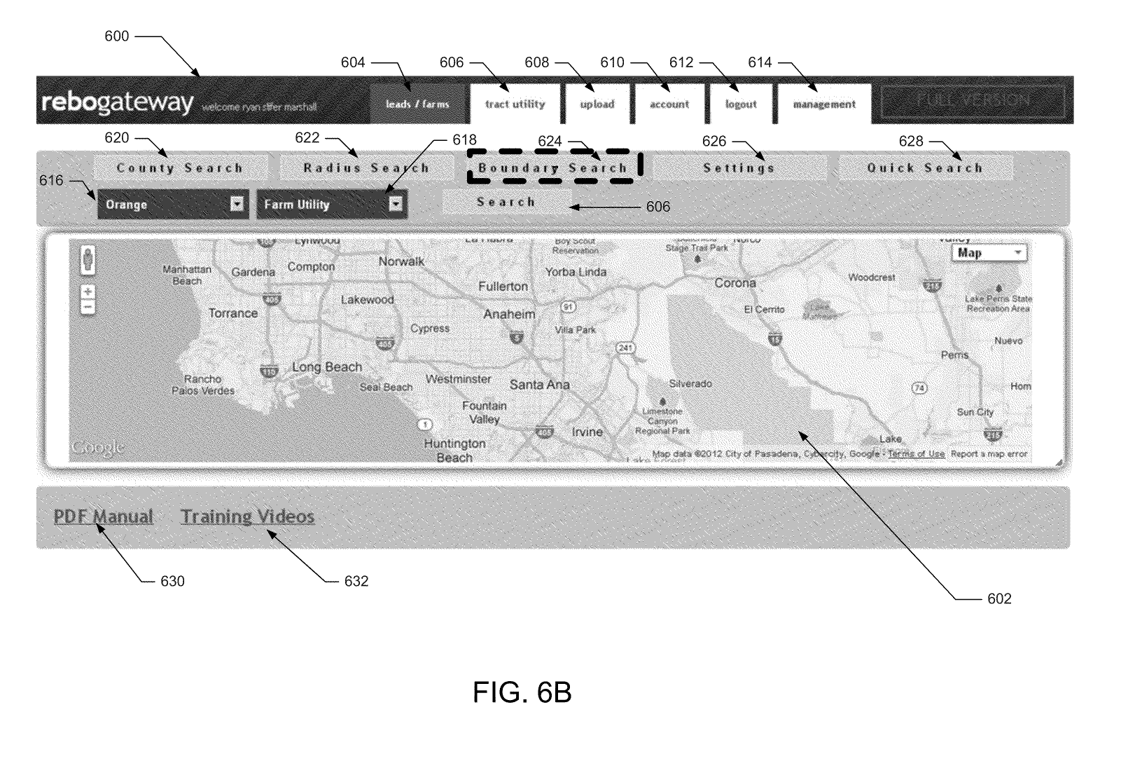

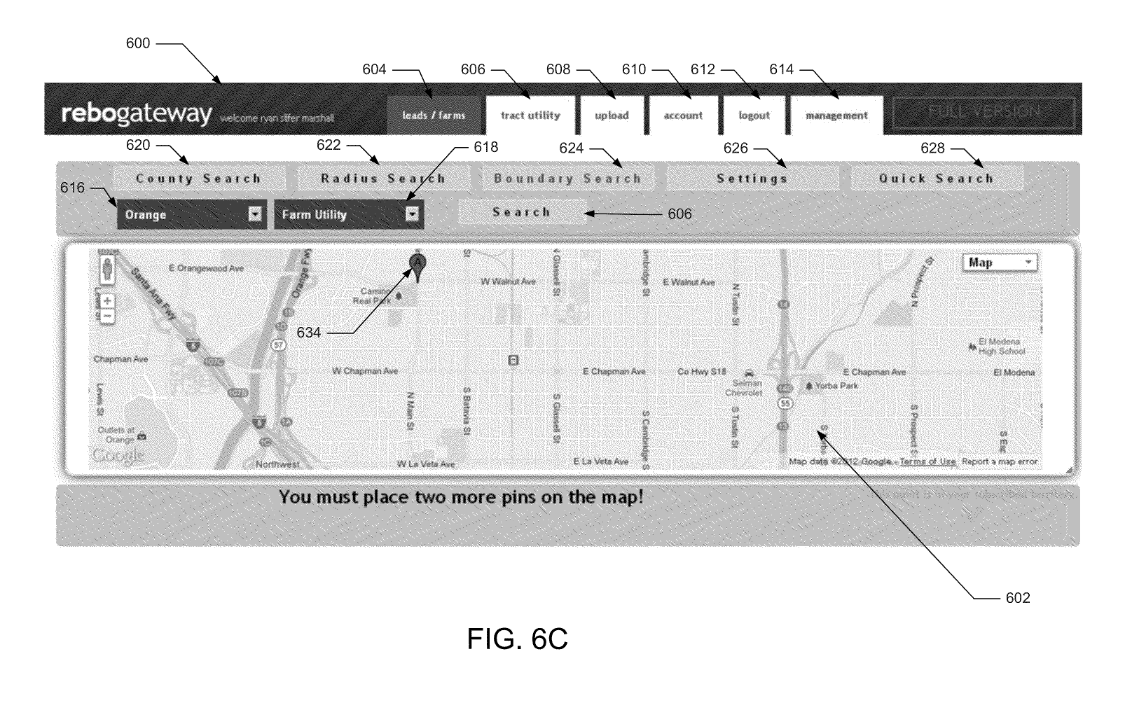

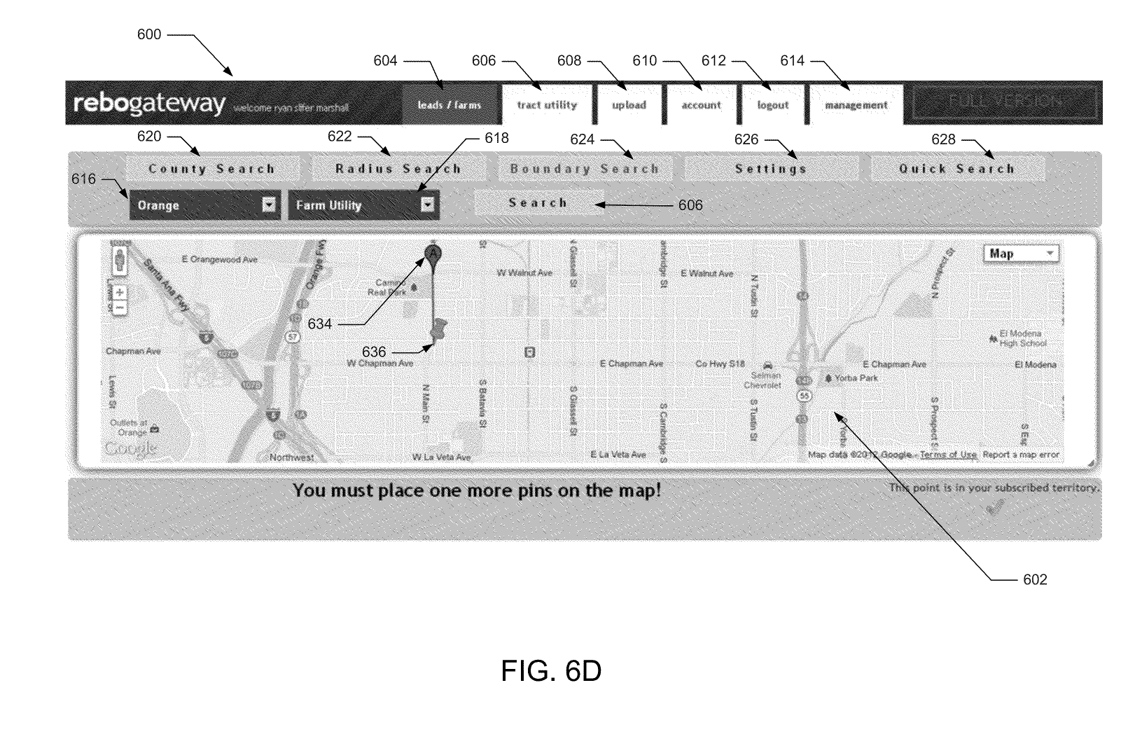

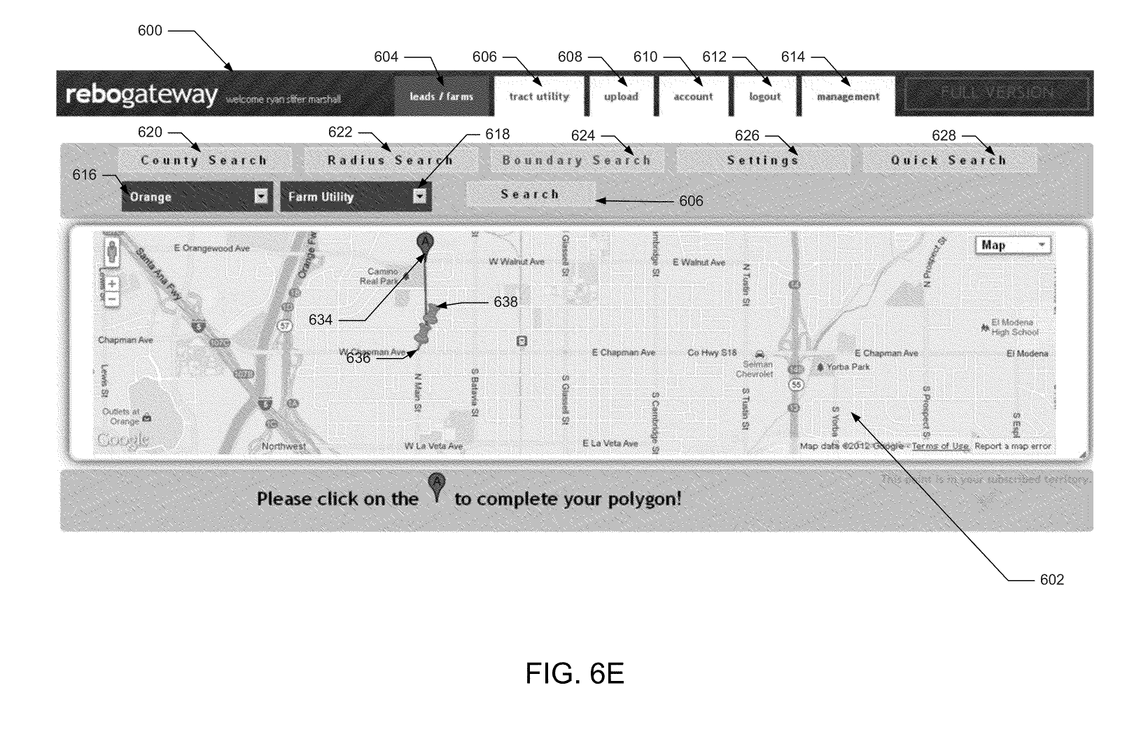

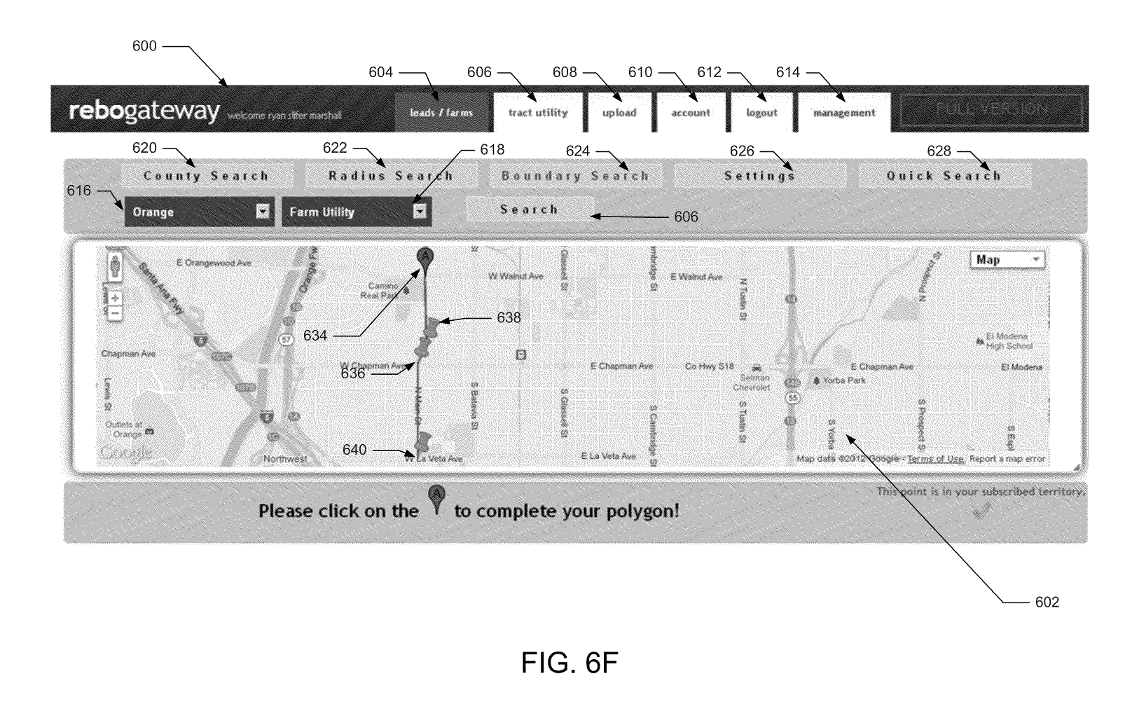

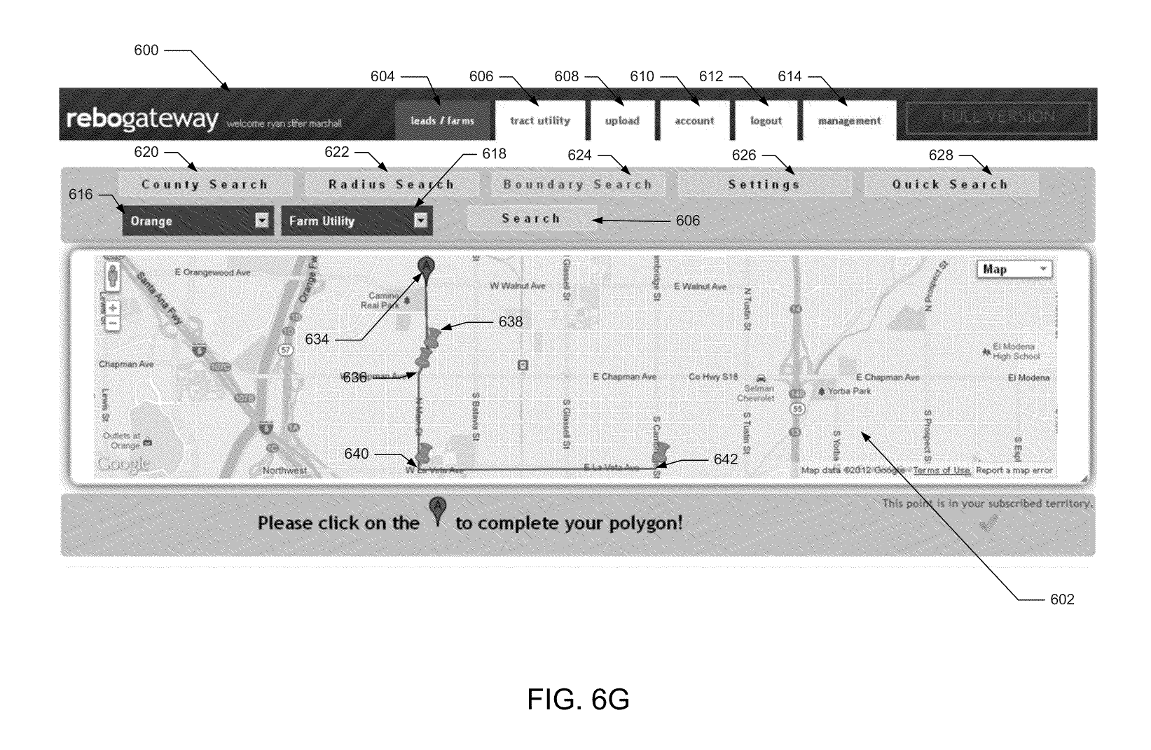

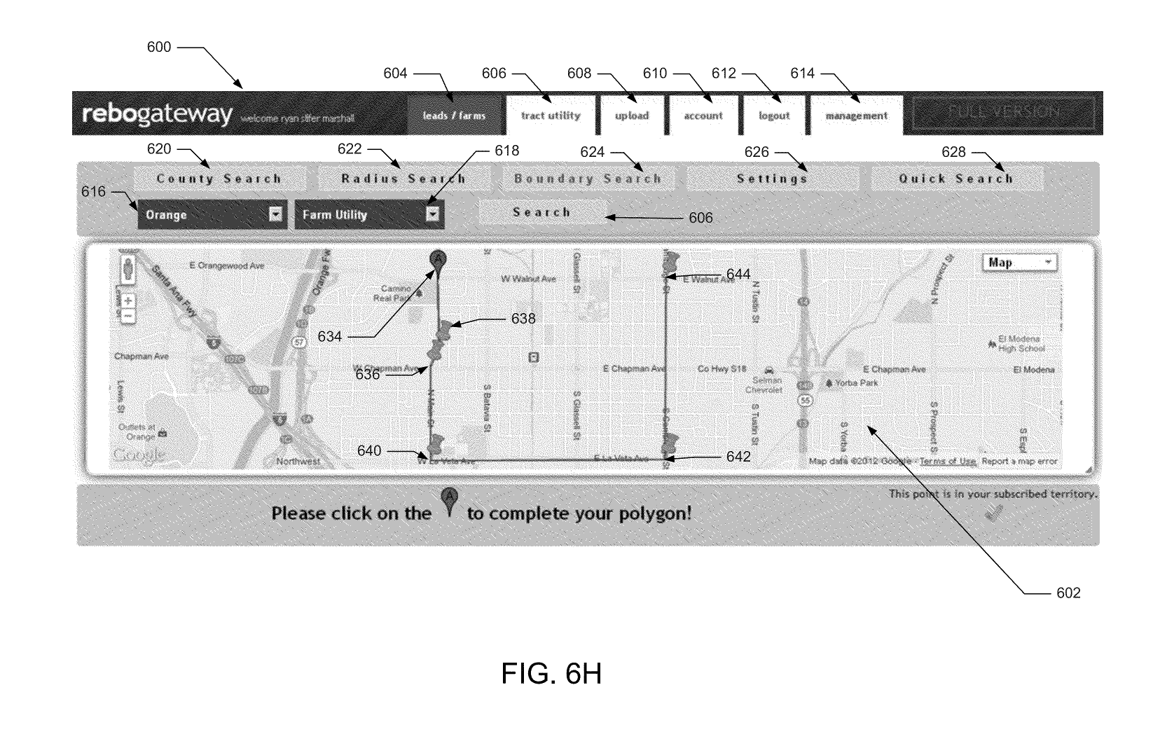

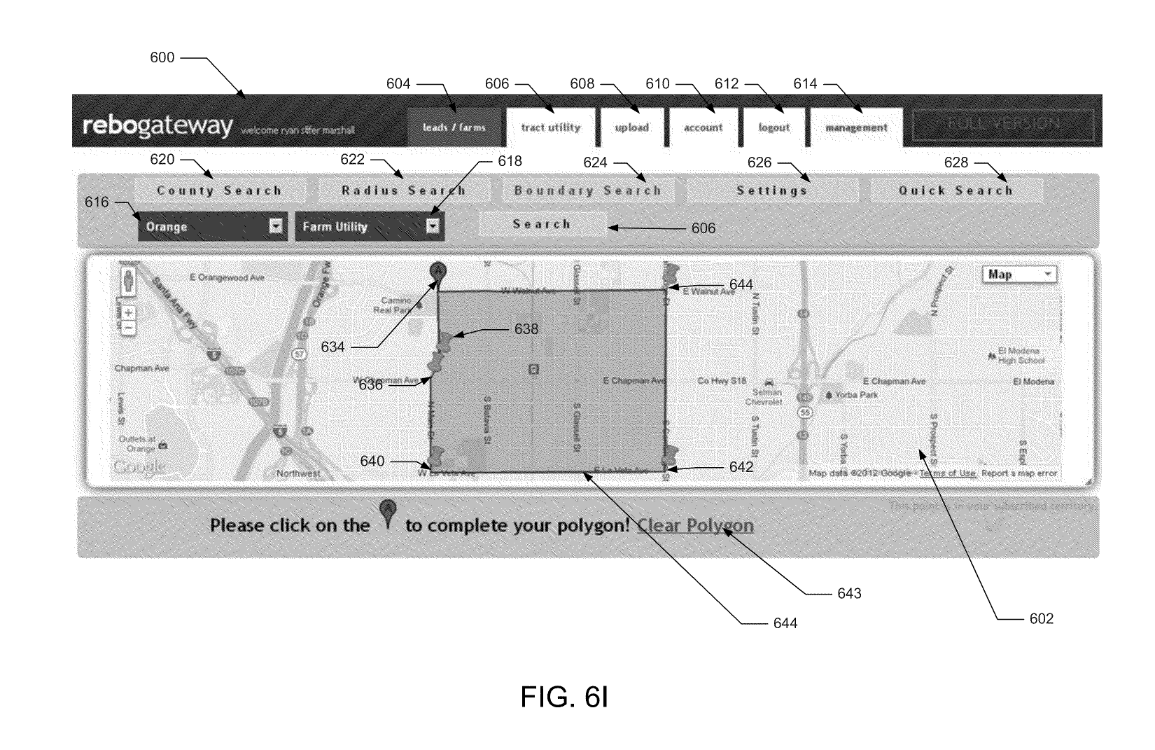

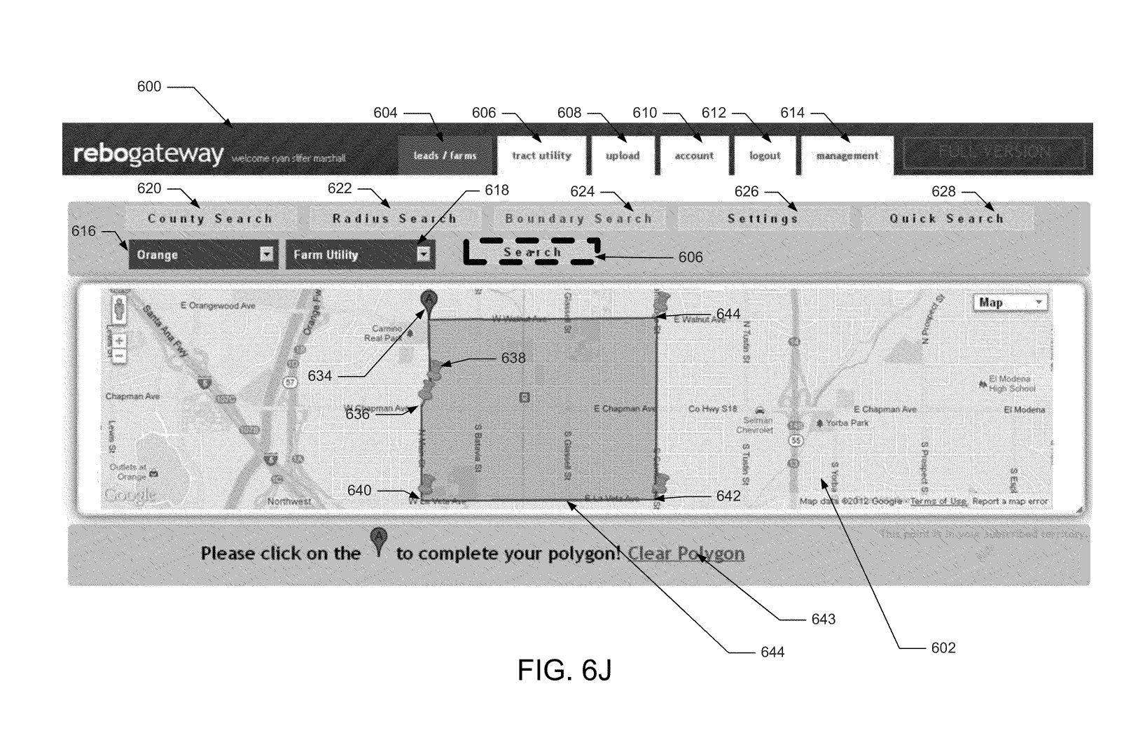

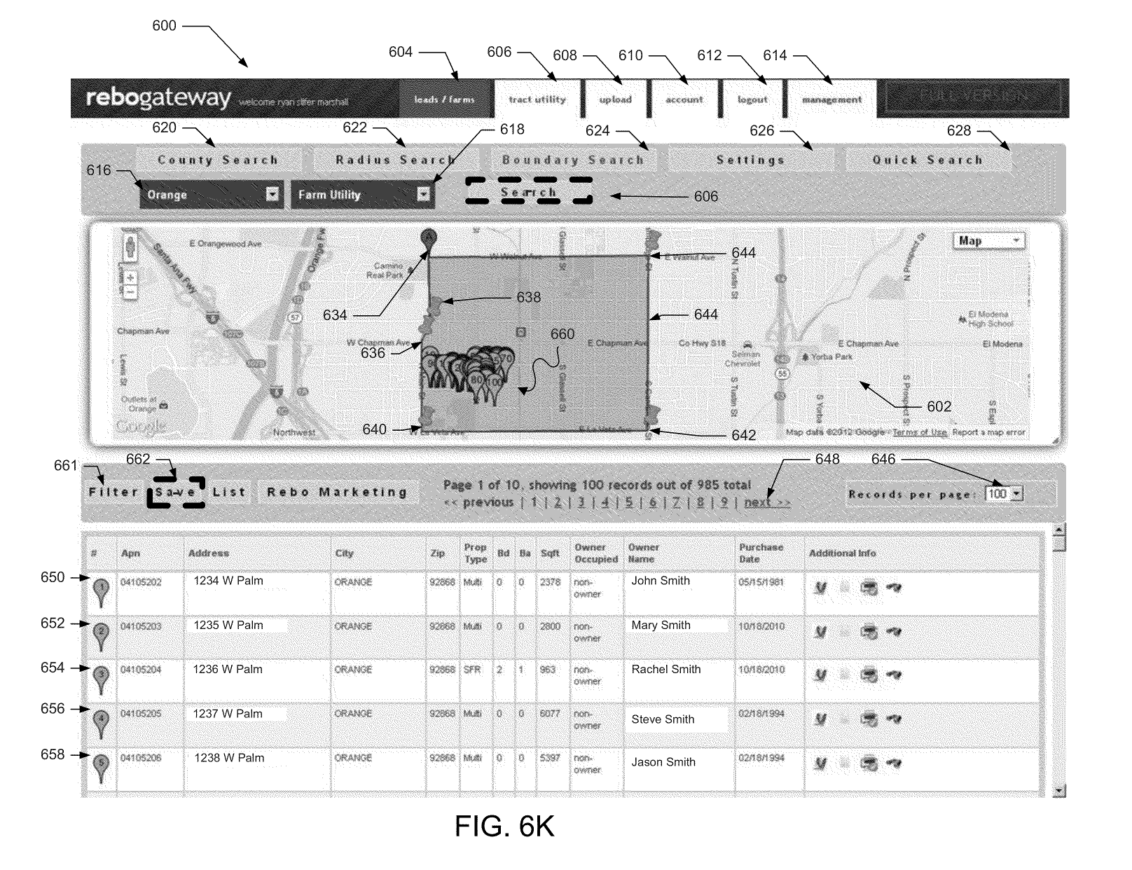

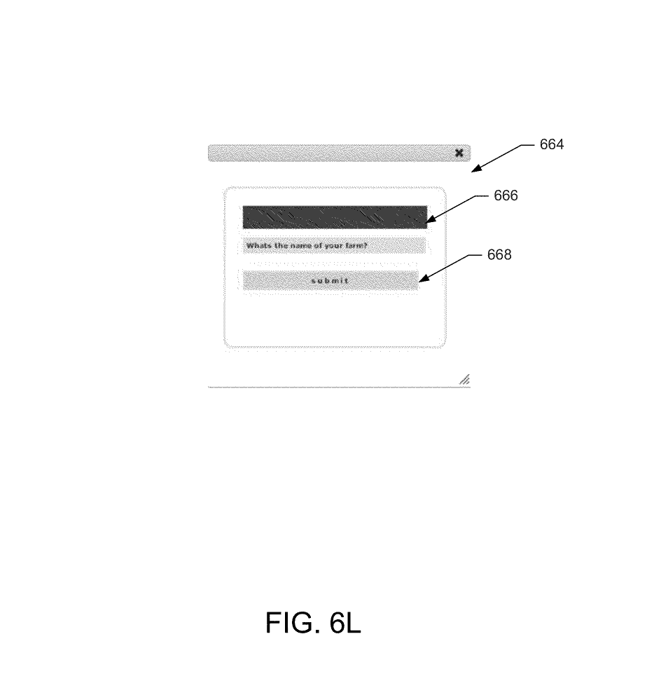

Referring to FIGS. 6A to 6M, these example screen shots generally show an example illustrating receiving an assignment of real estate property data to a real estate group based on a real estate property data generated based on a created search area or boundary. In this example, search area module 312 creates the boundary based on positions selected on a displayed map. Thereafter, in response to a search request, real estate property module 318 generates real estate property data results based on the created boundary. After the results are generated, real estate property module 316 receives an assignment request for assigning real estate property data to a a real estate group.

As illustrated in FIG. 6A, in this example, after the realtor logs into information processing system 302, display device 112 of realtor interface 304 displays example home screen 600. More specifically, the realtor interface displays map 602, a plurality of tabs, a plurality of drop down boxes, a plurality of buttons and a plurality of links. In this example, the plurality of tabs includes leads/farm tab 604, track utility tab 606, upload tab 608, account tab 610, logout tab 612 and management tab 614. The plurality of drop down boxes includes select county drop down box 616 and lead type drop down box 618. The plurality of buttons includes county search button 620, radius search button 622, boundary search button 624, settings button 626 and quick search button 628. The plurality of links includes PDF manual link 630 and training video link 632.

In this example, select county drop down box 616 allows the realtor to select one of a plurality of county selections. In this example, real estate property module 318 is configured to generate real estate property data based on the selected county selection. As shown in FIG. 6B, in this example, the realtor has selected the Orange County selection as indicated by select county drop down box 616. In an alternative embodiment, real estate property module 318 may be configured to generate real estate property data based on more than one county selection.

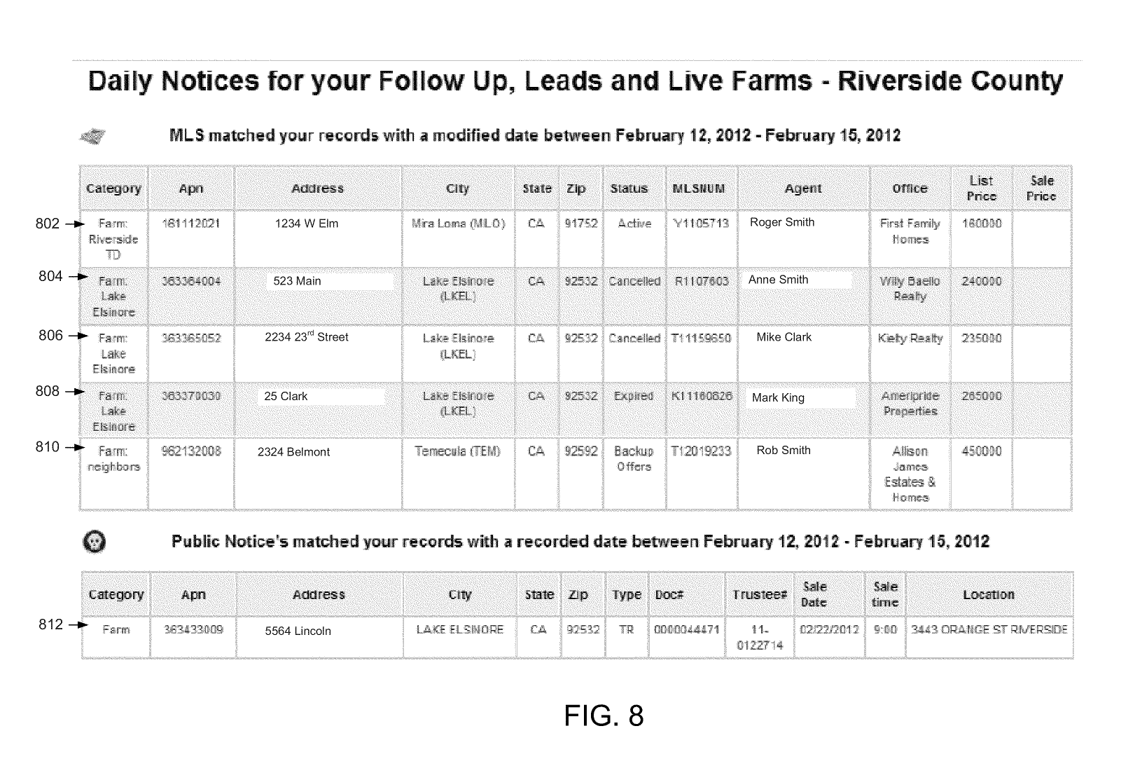

Referring back to FIG. 6A, in this example, lead type drop down box 618 allows the realtor to select one of a plurality of lead type selections. In this example, in response to a selection of the Farm Utility lead type selection, system 100 allows the realtor to cause system 100 to build or create real estate property groups and request lead notifications for the real estate property assigned to the real estate property groups. As illustrated in FIG. 8, the realtor has selected the Farm Utility lead type selection as indicated by the lead type drop down box 618.

In this example, in response to boundary search button 624 being selected, search area module 312 allows the realtor to locate a desired area on map 602 to create a search area or boundary. After a desired area is located, search area module 312 creates the boundary based on received selections.

As illustrated in FIG. 6C, the realtor has selected a first position of map 602. In response to the first position being selected, realtor interface 304 displays first marker or first pin 634 which is associated with the letter “A”. In this example, first pin 634 is displayed as a balloon marker. In this example, the boundary is created by selecting at least four consecutive positions on map 602. An appropriate message such as “You must place two more pins on the map!” is provided to the realtor visually such as in a message display, or through suitable audio or audiovisual displays.

As illustrated in FIG. 6D, the realtor has selected a second position of map 602. In response to the second position being selected, realtor interface 304 displays second marker or second pin 636. An appropriate message such as “You must place one more pin on the map!” is provided to the realtor visually such as in a message display, or through suitable audio or audiovisual displays.

As illustrated in FIG. 6E, the realtor has selected a third position of map 602. In response to the third position being selected, realtor interface 304 displays third marker or third pin 638. An appropriate message such as “Please click on “A” to complete your polygon!” is provided to the realtor visually such as in a message display, or through suitable audio or audiovisual displays.

As illustrated in FIG. 6F, the realtor has selected a fourth position of map 602. In response to the fourth position being selected, realtor interface 304 displays fourth marker or fourth pin 640. An appropriate message such as “Please click on “A” to complete your polygon!” is provided to the realtor visually such as in a message display, or through suitable audio or audiovisual displays.

As illustrated in FIG. 6G, the realtor has selected a fifth position of map 602. In response to the fifth position being selected, realtor interface 304 displays fifth marker or fifth pin 642. An appropriate message such as “Please click on “A” to complete your polygon!” is provided to the realtor visually such as in a message display, or through suitable audio or audiovisual displays.

As illustrated in FIG. 6H, the realtor has selected a sixth position of map 602. In response to the sixth position being selected, realtor interface 304 displays sixth marker or sixth pin 644. An appropriate message such as “Please click on “A” to complete your polygon!” is provided to the realtor visually such as in a message display, or through suitable audio or audiovisual displays.

As illustrated in FIG. 6I, the realtor has selected a seventh position of map 602. In this example, the seventh position is located at first pin 634. By selecting first pin 634, search area module 312 creates search area or boundary 644. That is, the polygon is complete.

In this example, after search area module 312 creates boundary 644, in response to a selection of search button 606, real estate property generation module 314 generates real estate property data based on the created search area. As indicated by the highlighted border of search button 606 in FIG. 6J, in this example, the realtor selects search button 606 after search area module 314 creates boundary 644.

As shown in FIG. 6K, in response to the selection of search button 606, real estate property module 318 generates real estate property data. In this example, the generated property real estate data includes record data which representative of 985 separate real estate properties and information associated with the real estate properties. An appropriate message such as “Page 1 of 10, showing 100 records out of 985 total” is provided to the realtor visually such as in a message display, or through suitable audio or audiovisual displays.

As illustrated in FIG. 6K, in this example, real estate property generation module 314 generates real estate property data which includes record data including or associated with balloon markers. In this example, each separate balloon marker is associated with a separate number. More specifically, the generated real estate property data includes first record 650 associated with balloon marker number one, second record 652 associated with balloon marker number two, third record 654 associated with balloon marker number three, fourth record 656 associated with balloon marker number five and fifth record 658 associated with balloon marker number six. In addition, as displayed in map 602 of FIG. 6K, realtor interface 304 displays each balloon marker that is associated with the first one hundred records of the 985 total generated records, as referenced generally by arrow 660.

It should be appreciated that, in this example, the realtor interface 304 only displays the balloon markers in map 602 that correspond to the currently displayed records (i.e., the first 100 hundred real estate property records). In another embodiment, realtor interface 304 displays all of the generated records.

As shown in FIG. 6K, in this example, realtor interface 304 displays, among other buttons, save button 662. As indicated by the highlighted border of save button 662 in FIG. 6K, in this example, the realtor selects save button 662. In this example, in response to the selection of save button 662, real estate property assignment module 316 causes realtor interface 304 to display save window 664 as illustrated in FIG. 6L.

As shown in FIG. 6L, save window 664 includes name window 666 and submit button 668. In this example, name window 666 allows the realtor to name the group of real estate property data results generated in FIG. 6K (i.e., the 985 records). After the realtor enters a name for the real estate property data, and in response to a selection of submit button 668, real estate property assignment module 316 causes the realtor interface 304 to transmits real estate group data representative of which real estate property data was desired to be assigned to a group by the realtor. It should be appreciated that in some example embodiments, system 100 allows the realtor cause system 100 to create any suitable amount of real estate groups which include real estate property data.

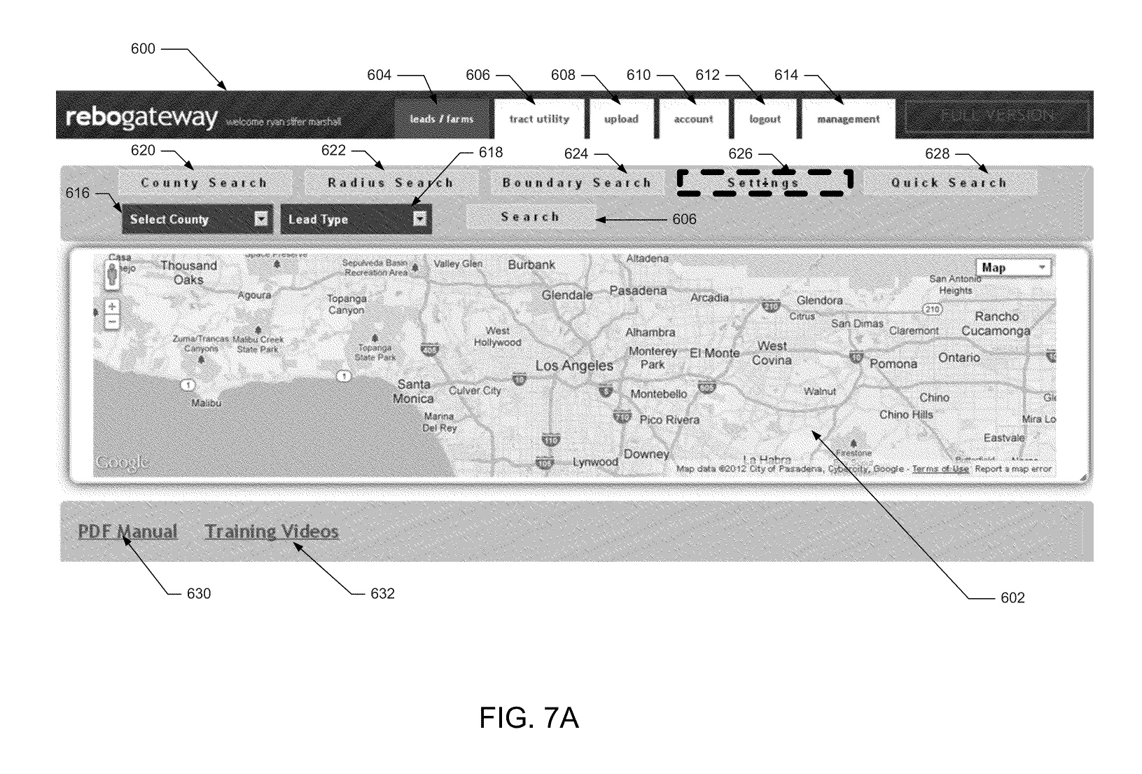

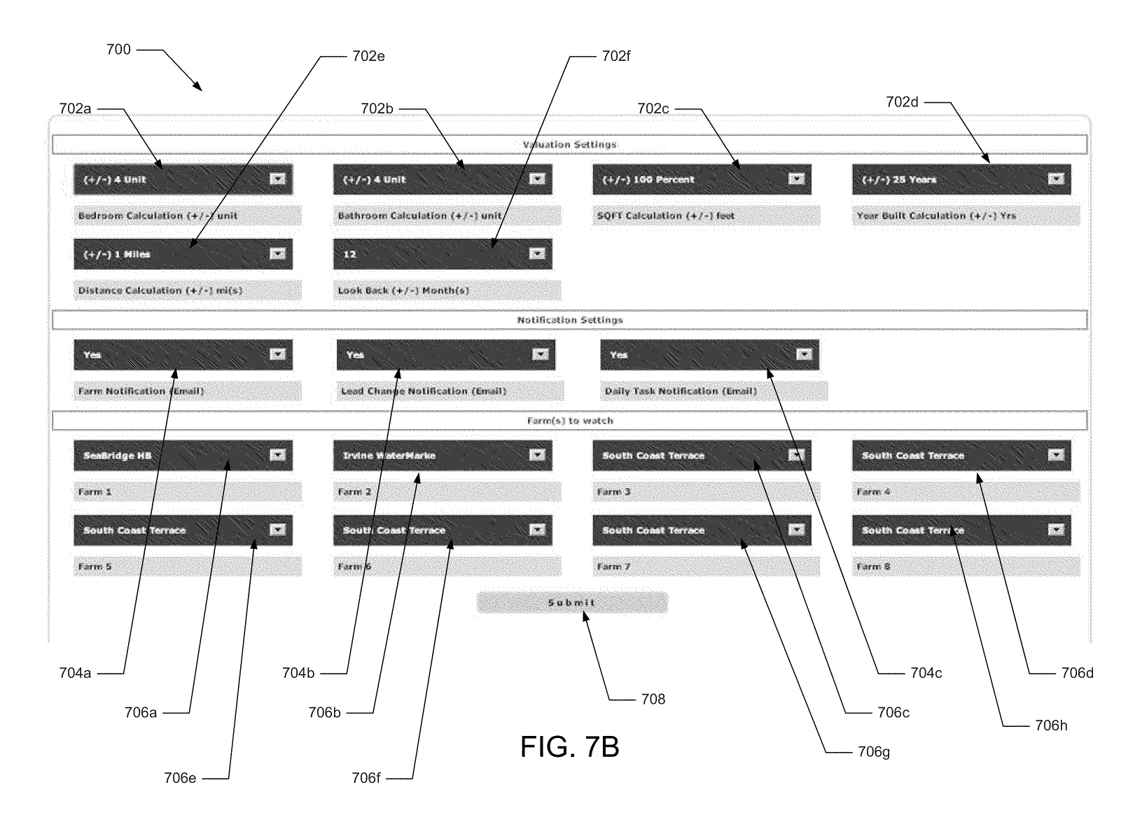

Referring to FIGS. 7A and 7B, these screen shots generally show, for each real estate group, the request notification module 318 receiving requests for notifications of any lead triggering events associated with the real estate property data assigned to the real estate group.

Referring to FIG. 7A, as indicated by the highlighted border of settings button 606, in this example, the realtor selects settings button 626. In response to settings button 626 being selected, request notification module 318 causes realtor interface 304 to display settings window 700.

More specifically, as shown in FIG. 7B, request notification module 318 causes realtor interface 304 to display sets of the following drop down boxes: (a) valuation settings drop down boxes 702a, 702b, 702c, 702d, 702e, 702f; (b) notification settings drop down boxes 704a, 704b and 704c; and (c) farm(s) to watch drop down boxes 706a, 706b, 706c, 706d, 706e, 706f, 706g, 706h.

In this example, each farm(s) to watch drop down box 706a, 706b, 706c, 706d, 706e, 706f, 706g, 706h allow the realtor to select one named real estate group selection. As illustrated in FIG. 7B, in this example, using the farm(s) to watch drop down boxes, the realtor has requested notifications for the following groups of real estate property data: (a) “Seabridge HB” as indicated by farm(s) to watch drop down box 706a; (b) “Irvine WaterMarke” as indicated by farm(s) to watch drop down box 706b; and (c) “South Coast Terrrace” as indicated by farm(s) to watch drop down box 706c. That is, in this example, the realtor has requested notification for three real estate groups. In this example, “South Coast Terrace” also appears in farm(s) to watch drop down boxes 706c, 706d, 706e, 706f, 706g and 706h because in this embodiment, each drop down box is configured to display at least one name of a group of real estate group.

In this example, notifications settings drop down boxes 704a, 704b and 704c allow the user to change settings for different types of notifications. For example, for each different type of notification, the realtor may operate with drop down boxes 704a, 704b and 704c to select between “Yes” and “No”. Such a selection allows the realtor to decide which types of notifications the realtor will receive. In one example, request notification module 318 receives a selection indicating a request to cause information processing system 302 to generate notifications only when a divorce is filed for real estate properties in the real estate groups.

In some embodiments, it should also be appreciated that by providing notifications for selected lead types for a real estate group, a real estate professional may save time locating these leads. For example, to receive these types of leads, a real estate professional may have to query millions of records sets for thousands of lead types to attempt to compile all of the lead types which are provided by the system described herein.

In this example, after the realtor makes any changes to any of the settings, submit button 708 (as shown in FIG. 7B) is selected to save the changes.

In some example embodiments, system 100 limits the number of real estate groups a realtor may receive notifications for. For example, in one example embodiment, as illustrated in FIG. 7B, request notification module 318 allows the realtor to request notifications for up to eight real estate groups.

In the above described example, request notification module 318 employs drop down boxes to allow the realtor to request notifications for each of the real estate groups. It should be appreciated that, in other embodiments, the realtor may be allowed to request the notifications using any other suitable method.

In this example, after real estate property generation module 314 generates the real estate property data, system 100 allows the realtor to cause the realtor interface to change the number of records shown on each page by utilizing, for example, number of records per page drop down box 646, as shown in FIG. 6K. In some example embodiments, system 1100 allows the realtor to select any suitable number of records such as 10, 20, 50 or 100.

In this example, search area module 312 receives selections of up to ten map positions to create the search area. It should be appreciated that in other embodiments, search area module 312 receives selections up to any suitable number of positions to create the search area.

In this example, search area module 312 removes any displayed pins in response to a first selection of the first displayed marker or pin and a subsequent second selection of a clear polygon button. FIGS. 6I and 6J show an example clear polygon button 643.

In this example, in response to account tab 610 being selected, system 100 allows the realtor to make changes to the realtor's account, such as the realtor's password, name, address, email and phone number. In some example embodiments, the realtor may add or remove a county in which the realtor is allowed to conduct searches.

Referring to FIG. 8, this example screen shot generally shows notification generation module 324 causing realtor interface 304 to provide a notification based on received data representative of lead triggering event occurrences. In this example, realtor interface 304 receives notification data, via email, from information processing system 302.

As illustrated in FIG. 8, in this example, notification generation module 324 causes realtor interface 304 to provide the notifications by displaying the following six notifications: first notification 802; second notification 804; third notification 804, fourth notification 804, fifth notification 804; and sixth notification 804.

In this example, each displayed notification include real estate property data representative of a separate real estate property and data associated with the real estate property, such as data indicative of the real estate group that the real estate property is assigned to.

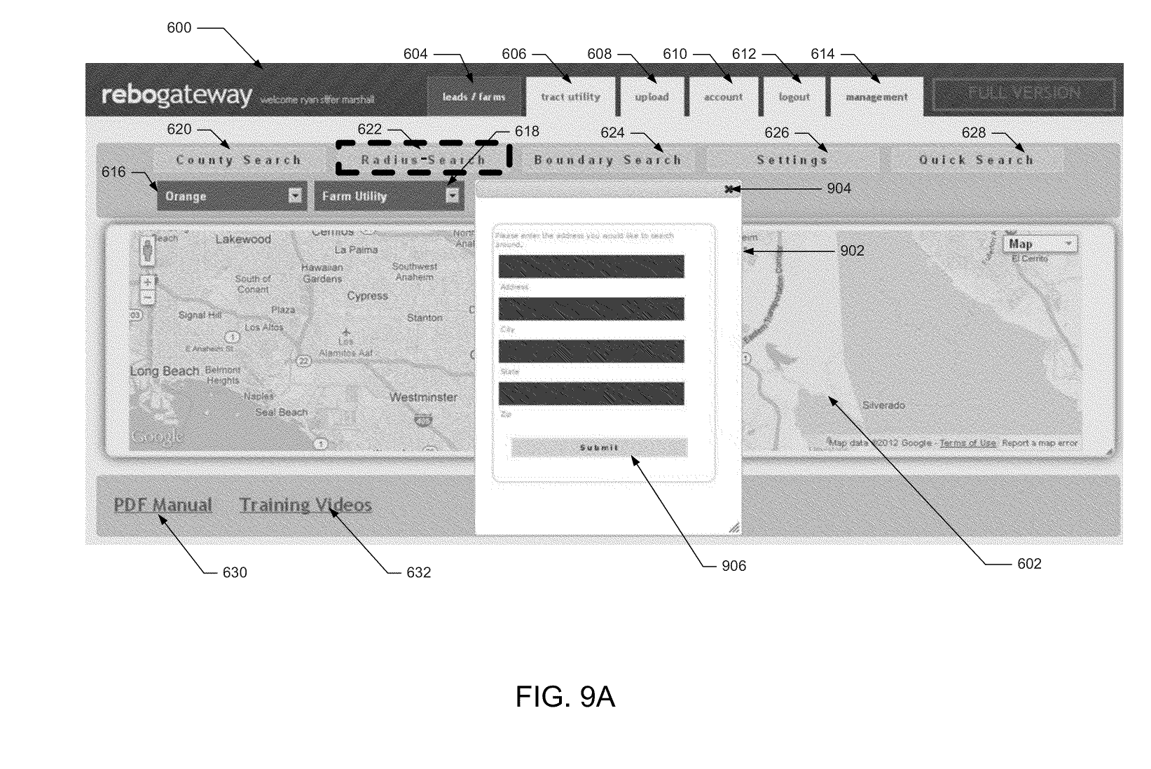

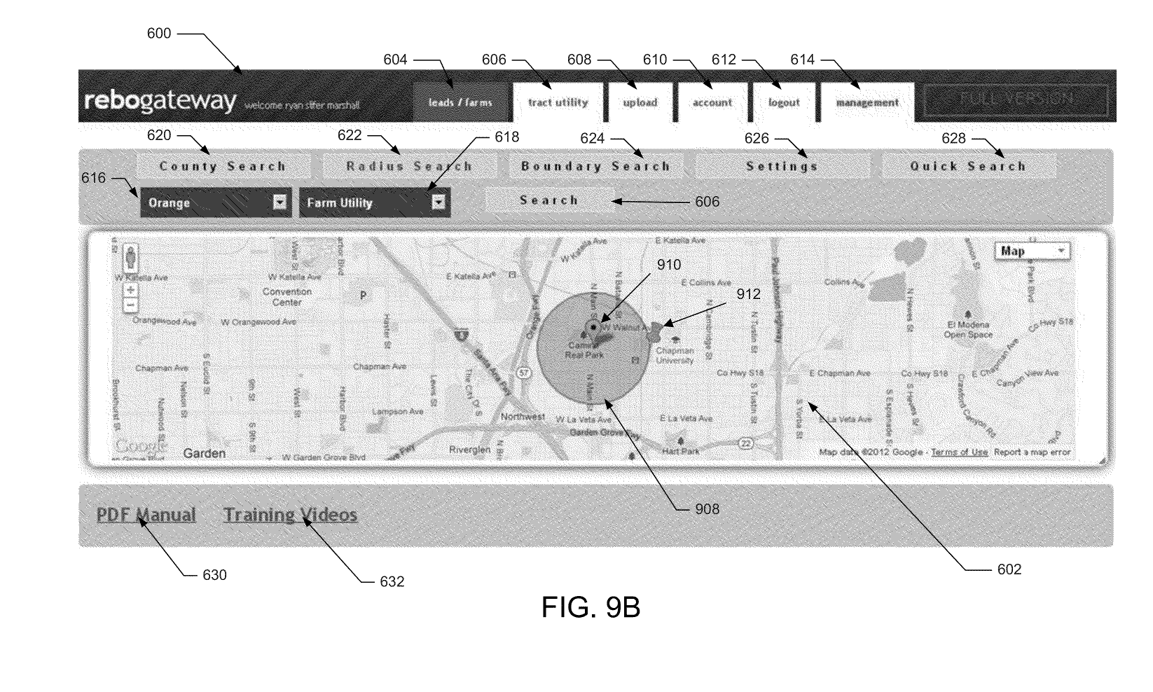

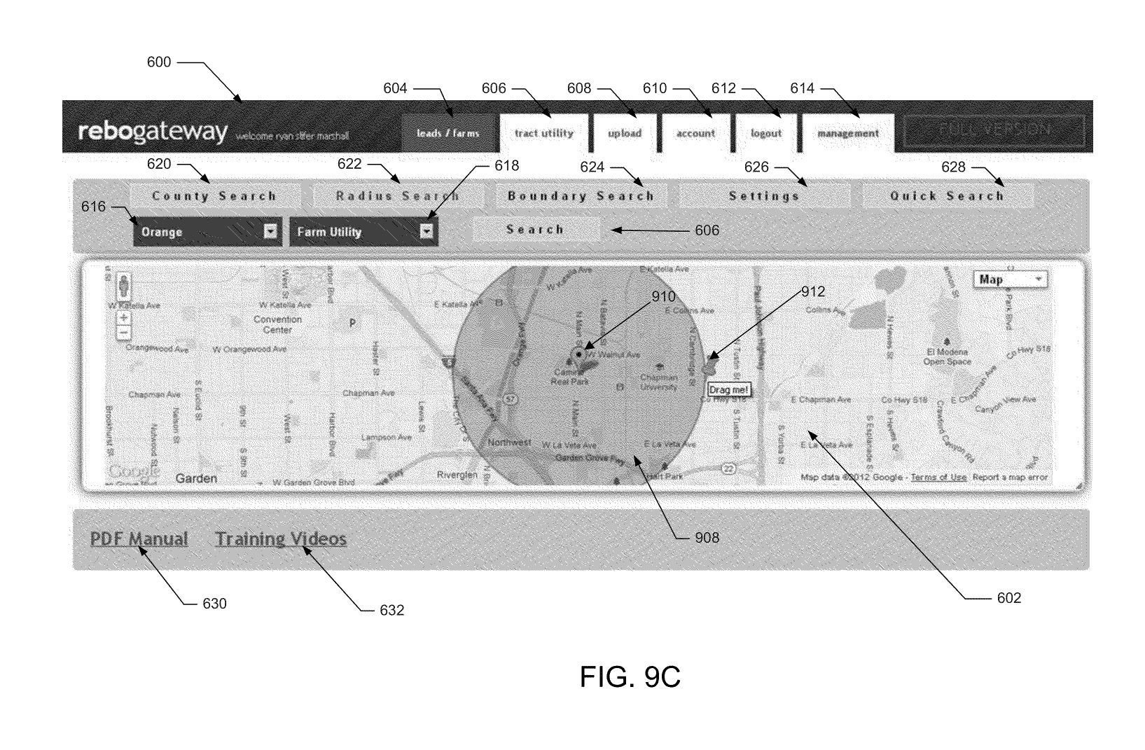

In some example embodiments, real estate property generation module 314 generates real estate property data based on an adjustable search area. For example, referring to FIGS. 9A to 9C, these screen shots generally show an example of real estate property generation module 314 generating real estate property data based on an adjustable circular-shaped search area.

More specifically, in this example, as indicated by the highlighted border of radius search button 606 in FIG. 9A, in this example, the realtor selects radius search button 622.

In response to the selection of radius search button 622, search area module 312 causes realtor interface 304 to display address search box 902 as shown in FIG. 9A. Search box 902 allows the realtor to enter address information such as a specific address, a city, a zip code and/or a state. In this example, when the realtor enters address information and selects submit button 906, real estate property generation module 314 causes the realtor interface 304 to display a map having a centered marker positioned based on the entered address information. Such a configuration allows the realtor to efficiently locate a desired area on map 602.

In this example, search area module 314 also receives map selections without entering any address information. For example, in response to a selection of close window button 904 shown in FIG. 9A, search area module 314 allows the realtor to search for and locate a desired map location by clicking on and dragging the map and/or zooming in and out of the map using input device 214.

As shown in FIG. 9B, in this example, in response to a selection of close window button 904, search area module 314 causes realtor interface 304 to display search area 908 having center marker or pin 910 and second pin 912. In this example, search area 908 is circular-shaped. It should be appreciated that, in other embodiments, search area 908 may have any other suitable shape, such as a square shape or rectangular shape.

In this example, search area module 312 adjusts the size of the search area. For example, as shown in FIG. 9B, search area 908 has a radius or distance which may be defined from center pin 910 to second pin 912. In this example, search area module 312 adjusts the radius of search area 908 by receiving data indicative of a selection second pin 912 and dragging pin 912 closer to or farther from center pin 910. FIG. 9C illustrates an example display after the realtor selected second pin 912 and caused second pin 912 to move further from center pin 910. Such a configuration allows the realtor to efficiently create a search area used to generate real estate property data.

Similar to the example embodiment described above with reference to FIGS. 6A to 6L, in this example, after search area 908 is set, the realtor may select search button 606 to cause real estate property generation module 318 to generate real estate property data based on the set search area.

Referring back to FIG. 9B, in this example, real estate property generation module 314 is configured to cause realtor interface 304 to automatically initially set the radius of the search area to a default distance of 0.25 miles. It should be appreciated that in other embodiments, real estate property generation module 314 may be configured to cause realtor interface 304 to automatically initially set the radius to any suitable distance.

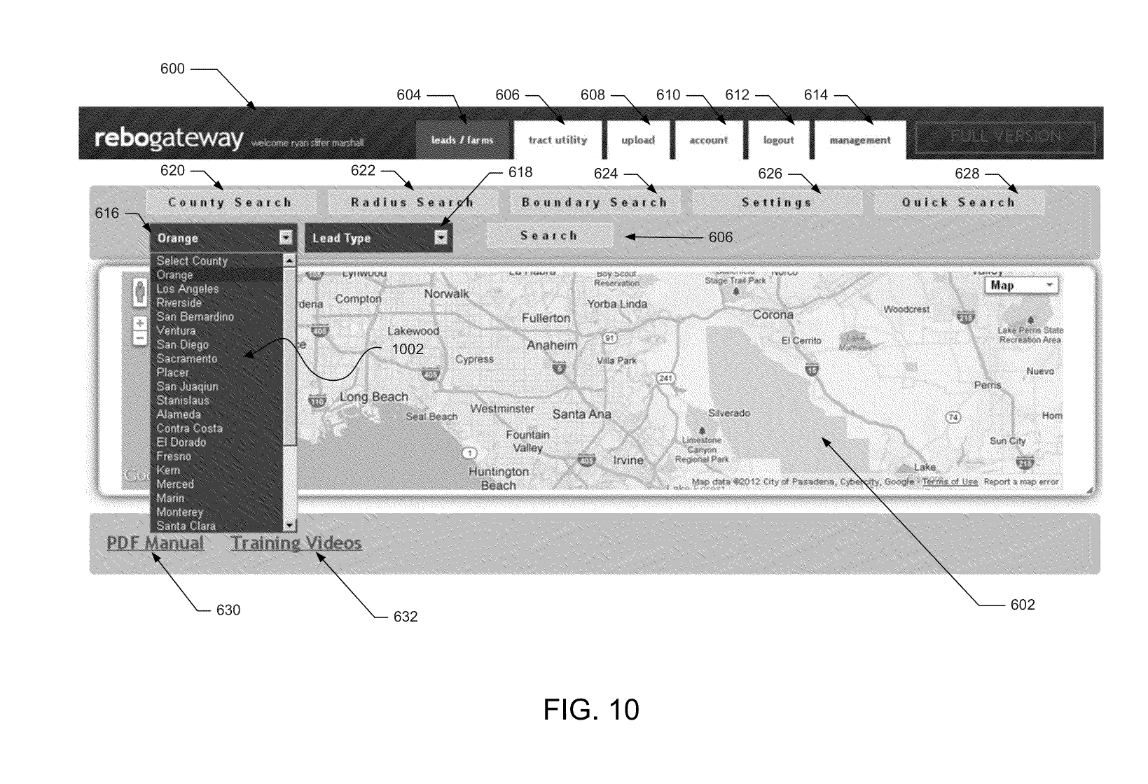

In some example embodiments, as described above, realtor interface 304 searches for real estate property data based on a county selection. In one example, as shown in FIG. 10, in response to a selection of select county drop down box 616, realtor interface 304 displays a plurality of county selections which are referenced generally by arrow 1002.

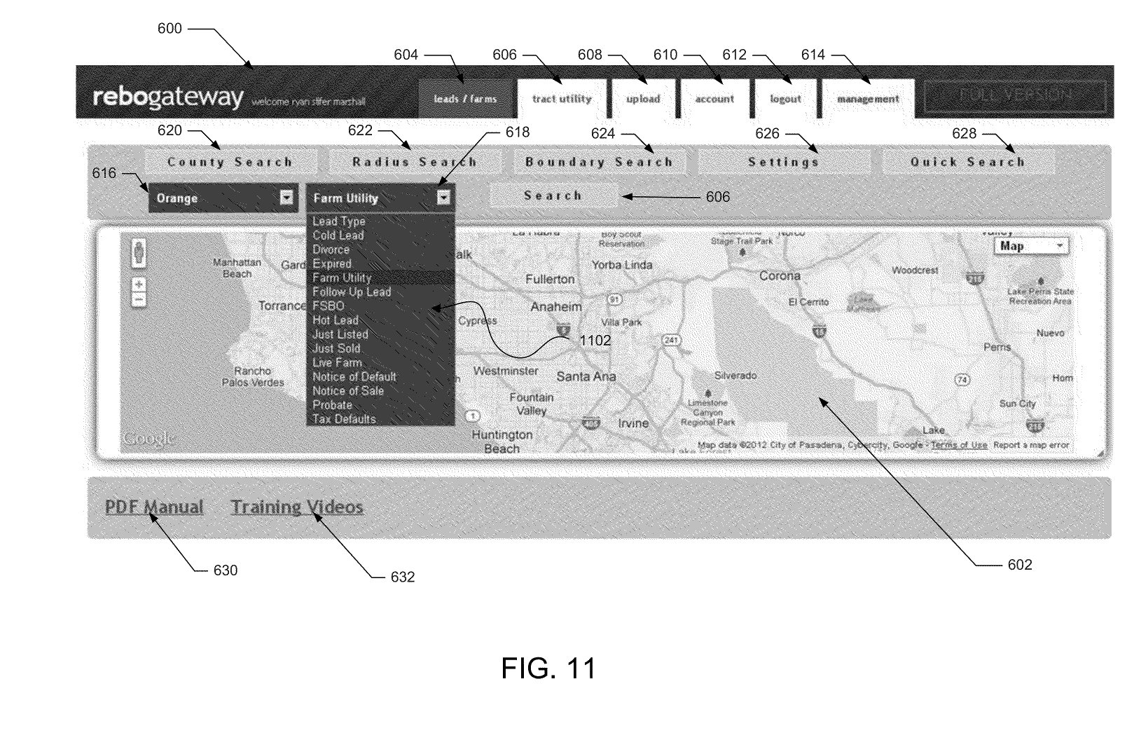

In some example embodiments, as described above, realtor interface 304 receives data indicating a selection of a lead type. In one example, as shown in FIG. 11, in response to a selection of select county drop down box 616, realtor interface 304 displays a plurality of lead types which are referenced generally by arrow 1102.

In some example embodiments, real estate property assignment module 316 assigns real estate property data to a real estate group based on a file. For example, where a realtor may already possess an electronic spreadsheet which includes data of a list of properties, in response to a selection of upload tab 608, real estate property assignment module 316 causes realtor interface 304 to display a window which allows the realtor to select or upload the spreadsheet. After the spreadsheet is selected, real estate property assignment module 316 may receive data indicating a name for the uploaded list of properties. In this example, in response to selection of a submit button, assignment module 316 assigns the uploaded real estate property data of the spreadsheet to a real estate group.

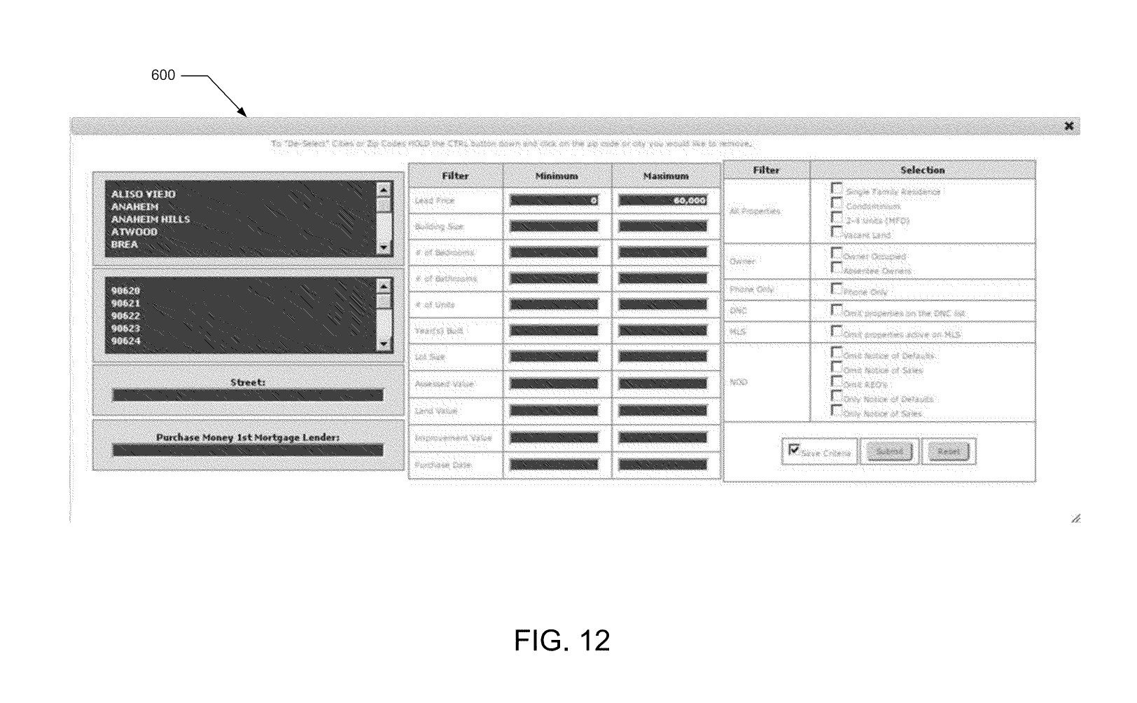

In some example embodiments, filter module 326 is configured to filter generated real estate property data. For example, referring to FIG. 12, in response to a selection of a filter button (e.g., filter button 661 shown in FIG. 661), filter module 326 causes realtor interface 304 to display filter window 1200. In this example, filter window includes a plurality of selections, fields and check boxes to filter real estate property data.

In some example embodiments, information processing system 302 determines when to generate and provide a notification. In some example embodiments, the determination of when to generate and provide any notifications is determined based on time. For example, in some example embodiments, information processing system 302 is configured to provide notifications in the morning. In some example embodiments, the determination of when to generate and transmit any notifications is determined based on the real estate property data, determined based on the type of real estate property data, determined based on a location of the realtor interface, determined based on the type of realtor interface, determined based on the operating system of the realtor interface, determined based on the version of the operating system of the realtor interface, a unique identifier of the realtor interface (e.g., a Unique Device Identifier), determined based on a time zone, or determined based on any other suitable method or criteria.

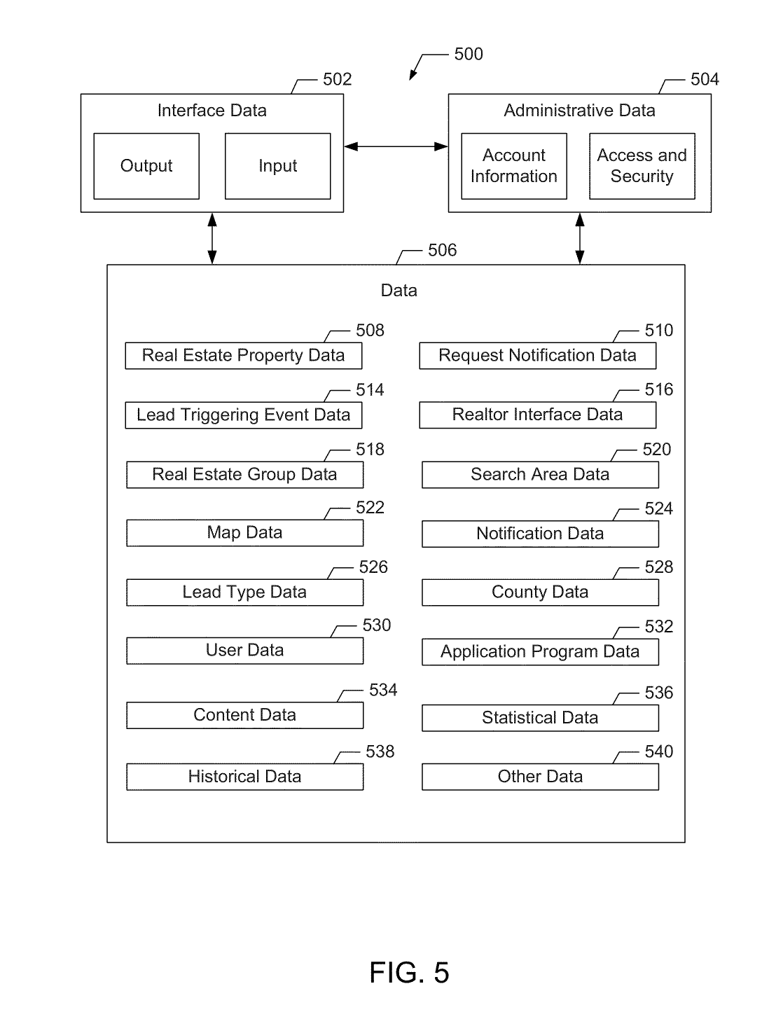

FIG. 5 is a block diagram of an example data architecture 500. In this example embodiment, data interface data 502, administrative data 504, and data 506 interact with each other, for example, based on user commands or requests. Interface data 502, administrative data 504, and data 506 may be stored on any suitable storage medium (e.g., database system 310 and/or server 226). It should be appreciated that different types of data may use different data formats, storage mechanisms, etc. Further, various applications may be associated with processing interface data 502, administrative data 504, and data 506. Various other or different types of data may be included in the example data architecture 500.

Interface data 502 may include input and output data of various kinds. For example, input data may include mouse click data, scrolling data, hover data, keyboard data, touch screen data, voice recognition data, etc., while output data may include image data, text data, video data, audio data, etc. Interface data 502 may include formatting, user interface options, links or access to other websites or applications, and the like. Interface data 502 may include applications used to provide or monitor interface activities and handle input and output data.

Administrative data 504 may include data and applications regarding user accounts. For example, administrative data 504 may include information used for updating accounts, such as creating or modifying user accounts and/or host accounts. Further, administrative data 504 may include access data and/or security data. Administrative data 504 may include a terms of service agreement. Administrative data 504 may interact with interface data in various manners, providing realtor interface 304 with administrative features, such as implementing a user login and the like.

Data 506 may include, for example, real estate property data 508, request notification data 510, lead triggering event data 514, realtor interface data 516, real estate group data 518, search area data 520, map data 522, notification data 524, lead type data 526, county data 528, user data 530, application program data 532, content data 534, statistical data 536, historical data 538 and/or other data 540.

Real estate property data 508 may include data representative of at least one of: divorce filings; probate filings; notices of sale; tax defaults; notices of default; cold leads; hot leads; expired leads; follow up leads; FSBO listings; properties just listed; properties just sold; type of leads (e.g., divorce, notice of default, tax line, etc.); listing date; name of the owner; address; city; zip code; street; county; purchase money first mortgage lender; beneficiary; trustee; trustor; price; loan amounts; building size; number of bedrooms; number of bathroom; number of units; year built; lot size; assessed value; improvement value; purchase date; property type; owner type; phone numbers on a “Do-Not-Call” registry; whether a property is bank owned; phone numbers; trustee number; loan data; sale date; sale location; delinquent amount; minimum bid; reason a notice of sale was filed; recorded date; MLS activity; whether a property is listed by another realtor; comparable properties; market trend; public sale; public financing; neighbor data; a number of days a property is on the market; property taxes; bankruptcy records; tax lien records; cash buyers; schools; population demographics; sales history of a property; comparable sales in the area; whether a phone number is on the National “Do-Not-Call” registry; environmental hazard reports; real estate properties; other property records; other court case filings; active MLS listings; sold MLS listings; expired MLS listings; foreclosure listings; and 1-800 sign call leads.

Request notification data 510 may include data representative of a realtor request for notifications of any lead triggering events.

Lead triggering event data 514 may include data representative of at least one of: data representative of at least one of: divorce filings; probate filings; notices of sale; tax defaults; notices of default; cold leads; hot leads; expired leads; follow up leads; FSBO listings; properties just listed; properties just sold; type of leads (e.g., divorce, notice of default, tax line, etc.); listing date; name of the owner; address; city; zip code; street; county; purchase money first mortgage lender; beneficiary; trustee; trustor; price; loan amounts; building size; number of bedrooms; number of bathroom; number of units; year built; lot size; assessed value; improvement value; purchase date; property type; owner type; phone numbers on a “Do-Not-Call” registry; whether a property is bank owned; phone numbers; trustee number; loan data; sale date; sale location; delinquent amount; minimum bid; reason a notice of sale was filed; recorded date; MLS activity; whether a property is listed by another realtor; comparable properties; market trend; public sale; public financing; neighbor data; a number of days a property is on the market; property taxes; bankruptcy records; tax lien records; cash buyers; schools; population demographics; sales history of a property; comparable sales in the area; whether a phone number is on the National “Do-Not-Call” registry; environmental hazard reports; real estate properties; other property records; other court case filings; active MLS listings; sold MLS listings; expired MLS listings; foreclosure listings; and 1-800 sign call leads.

Realtor interface data 516 may include at least one of data representative of: the location of the realtor device; the type of realtor device; the operating system of the realtor device; the version of the operating system of the realtor device; the unique identifier of the realtor device; the language employed by the realtor device.

Real estate group data 518 may include data representative of which real estate properties are assigned to which real estate groups or which real estate properties correspond to which real estate groups.

Search area data 520 may include data representative of at least one: borders; selectable borders; search area sizes; search area shapes; boundaries; markers; balloon markers; pins; letters; numbers; polygons; distances of the search area; and radius of a circular-shaped area.

Map data 522 may include data representative of at least one of: maps; positions of the map; and zooming in and out buttons.

Notification data 524 may include data representative of at least one of: emails; texts; or any other suitable notification methods.

Lead type data 526 may include data representative lead type selections such as the selections displayed in FIG. 11.

County data 528 may include data representative of the county selections.

User data 530 may include data representative of user profile data such as the gender of the user of the realtor interface.

Application program data 532 may include applications which may be downloaded or requested by the realtor interface. Applications may be designed to help a user to perform specific tasks. Applications may include enterprise software, accounting software, office suites, graphics software and media players.

Content data 534 may include any suitable content such as audio data, video data image data.

Statistical data 536 may include data used for providing reports including graphs, forecasts, recommendations, calculators, depreciation schedules, tax information, etc., including equations and other data used for statistical analysis.

Historical data 538 may include past data representative of: past sales data, historical list prices, actual sale prices, etc.

Other data 540 may include data representative of at least one of: time zones; selected choices from drop down menus; time meters; databases; programs; files; libraries; pricing data; operations data; tagging data; display interface buttons; tabs; the name field; links and usage data.

Display interface buttons may include data representative of at least one of: the county search button; the radius search button; the boundary search button; the settings button; the quick search button; the save button; the submit button.

Tabs may include data representative of at least one of: the leads/farm tab, the track utility tab, the upload tab, the account tab, the logout tab and management tab.

Links may include the PDF manual link and the training video link.

It should be appreciated that data may fall under one or more categories of data 506, and/or change with the passage of time.

It should be appreciated that a system administrator may load data 506 into the information processing system 302 as it becomes available. It should also be appreciated that data 506 may be tailored for a particular information processing system, for example, a realtor may request that a specific type of data that is not normally stored or used be stored in the database system 310. Accordingly, for example, customized reports may be provided to publishers using that specific data.

Data 506 may be maintained in various servers 108, in databases or other files. It should be appreciated that, for example, a realtor interface 104 may manipulate data 506 based on administrative data 504 and interface data 502 to provide requests or reports to users 114 and perform other associated tasks.

It should be appreciated that the systems and methods disclosed herein may help a real estate professional increase listings and thus property sales by providing notifications for real estate properties assigned to real estate groups. Further, by generating real estate property data based on the search areas described herein, the real estate professional can efficiently identify specific real estate properties in which notifications of any changes related to the real estate properties are desired. The systems and methods disclosed herein may also filter generated real estate property data. By filtering through the generated real estate property data, more relevant notifications may be provide to realtors.

It should also be appreciated that the systems and methods disclosed herein may help a real estate professional increase listings and thus property sales by saving time locating real estate leads by providing notifications for real estate properties assigned to real estate groups.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method comprising:
receiving, via an information processing system, real estate group data representative of an assignment of real estate property data to a real estate group;
for the real estate group, receiving, via the information processing system, a request for notification of lead triggering events associated with the real estate property data assigned to the real estate group;
for each real estate property data assigned to the real estate group:
determining, via the information processing system, whether a lead triggering event occurs based on received lead triggering event data; and
in response to a determination of an occurrence of a lead triggering event, generating, via the information processing system, notification data representative of the occurrence of the lead triggering event; and
transmitting, via the information processing system, the generated notification data to an information processing apparatus.

2. The method of claim 1, which includes generating, via the information processing system, the real estate property data based on a search area.

3. The method of claim 2, which includes causing a real estate professional interface to display the search area on a map based on a plurality of positions of the map being selected.

4. The method of claim 2, wherein the search area has a selectable border and a size.

5. The method of claim 2, which includes changing, via the information processing system, the size of the search area based on the selectable border being moved.

6. The method of claim 2, which includes changing, via the information processing system, the size of the search area based on the selectable border being moved.

7. The method of claim 1, wherein the lead triggering event data includes data selected from the group consisting of probate filing data, tax default data, notices of default data, cold lead data, hot lead data, expired lead data, follow up lead data, FSBO listing data, property just listed data, properties just sold data, type of lead data, listing date data, owner name data, address data, city data, zip code data, street data, county data, purchase money first mortgage lender data, beneficiary data, trustee data, trustor data, price data, loan amounts data, building size data, number of bedrooms data, number of bathrooms data, number of units data, year built data, lot size data, assessed value data, improvement value data, purchase date data, property type data, owner type data, “Do-Not-Call” registry data, data indicating whether a property is bank owned, phone number data, trustee number data, loan data; sale date; sale location data, delinquent amount data, minimum bid data, data indicating a reason a notice of sale was filed, recorded date data, MLS activity data, data indicating whether a property is listed by another real estate professional, comparable property data, market trend data, public sale data, public financing data, neighbor data; data indicating a number of days a property is on the market, property tax data, bankruptcy records data, tax lien records data, cash buyers data, school data, population demographics data, sales history of a property data, comparable sales in the area data, environmental hazard report data, court case filing data, active MLS listings data, sold MLS listings data, expired MLS listings data, foreclosure listings data, and 1-800 sign call leads data.

8. The method of claim 1, wherein the lead triggering event data includes data representative of a divorce filing.

9. The method of claim 1, wherein the lead triggering event data includes data representative of a notice of sale.

10. The method of claim 1, wherein the lead triggering event data includes data representative of a change of at least a portion of the real estate property data assigned to the real estate group.

11. The method of claim 1, further comprising receiving, via the information processing system, selections indicating a request for receiving notification data for designated types of lead triggering event data.

12. An information processing system comprising:
a processor; and
a memory device operatively coupled to the processor, the memory device storing instructions which when executed by the processor, cause the processor to:
(a) receive, from a real estate professional interface, real estate group data representative of assigned real estate property data to a real estate group;
(b) receive, via the real estate professional interface, request notification data representative of requested notifications of lead triggering events associated with the real estate property data assigned to the real estate group;
(c) for each real estate property data assigned to the real estate group:
(i) determine whether a lead triggering event occurs based on received lead triggering event data; and
(ii) in response to a determination of an occurrence of a lead triggering event, generate notification data representative of the occurrence of the lead triggering event.

13. The information processing system of claim 12, wherein the instructions, when executed by the processor, cause the processor to generate the real estate property data based on a created search area.

14. The information processing system of claim 13, wherein the instructions, when executed by the processor, cause the processor to filter the generated real estate property data.

15. The information processing system of claim 12, wherein the instructions, when executed by the processor, cause the processor to cause the real estate professional interface to assign:
(a) first real estate property data to a first real estate group; and
(b) second real estate property to a second real estate group.

16. The information processing system of claim 12, wherein the received lead triggering event data includes data representative of a change of at least a portion of the real estate property data assigned to the real estate group.

17. The information processing system of claim 12, wherein the received lead triggering event data includes data representative of a notice of sale.

18. A real estate professional interface comprising:
a processor;
a display device operatively coupled to the processor;
an input device operatively coupled to the processor;
a memory device operatively coupled to the processor, the memory device storing instructions which when executed by the processor, cause the processor, in cooperation with the display device, the input device and the memory device, to:
(a) assign real estate property data to a real estate group;
(b) for the real estate group, receive a request for a notification in response to a determination of a lead triggering event associated with the real estate property data assigned to the real estate group; and
(c) display the notification.

19. The real estate professional interface of claim 18, wherein the instructions, when executed by the processor, cause the processor to generate the real estate property data based on a created search area.

20. The real estate professional interface of claim 19, wherein the instructions, when executed by the processor, cause the processor to filter the generated real estate property data.

21. The real estate professional interface of claim 18, wherein the instructions, when executed by the processor, cause the processor to:
(a) assign first real estate property data to a first real estate group; and
(b) assign second real estate property to a second real estate group.
